(19) United States
(12) Patent Application Publication
(10) Pub. No.: US 2015/0199493 A1
(43) Pub. Date: Jul. 16, 2015

(54) Method and System for Delivering Healthcare Via Personalized Parameter Tracking Kits

(71) Applicant: CYTOBYTE, INC., Shaker Heights, OH (US)

(72) Inventors: Jacob Glenn, Shaker Heights, OH (US); Radu Iancu, Mayfield Heights, OH (US)

(73) Assignee: CYTOBYTE, INC., SHAKER HEIGHTS, OH (US)

(21) Appl. No.: 14/474,844

(22) Filed: Sep. 2, 2014

Related U.S. Application Data
(60) Provisional application No. 61/927,660, filed on Jan. 15, 2014.
(60) Provisional application No. 61/928,181, filed on Jan. 16, 2014.

(51) Int. Cl. G06F 19/00

(52) U.S. Cl. CPC G06F 19/3481; G06F 19/345

(57) ABSTRACT

Systems and methods of the invention relate to treatment of a health condition through the use of a personalized, technology agnostic kits for tracking of specific health and/or wellness parameters and a method for sharing parameters and distributing health and/or wellness advice between a treatment provider and a user. The secure communication can be established between a treatment provider and a user, wherein the treatment provider is communicating medical advice and/or health advice to manage the condition based on data representative of parameter(s) that can affect the condition. The user can select one or more devices that collect data related to the parameter(s) and the secure channel is used to communicate such data to the treatment provider that is handling the condition to allow for communicating the medical advice and/or health advice.

### CROSS-REFERENCE TO RELATED APPLICATIONS

This application claims the benefit of priority to U.S. Provisional Application Ser. No. 61/927,660, filed Jan. 15, 2014, and entitled “METHOD AND SYSTEM FOR SECURED DATA COMMUNICATION FOR HEALTH INSTRUCTIONS” and U.S. Provisional Application Ser. No. 61/928,181, filed Jan. 16, 2014, and entitled “METHOD AND SYSTEM FOR SOFTWARE KIT FOR DIAGNOSTICS.” The entireties of the aforementioned applications are incorporated herein by reference.

### BACKGROUND

1. Technical Field

Embodiments of the subject matter disclosed herein relate to the treatment of a health condition through the use of a personalized, technology agnostic kit for tracking of specific health and/or wellness parameters and a method for sharing parameters and distributing health and/or wellness advice between a treatment provider and a user.

2. Discussion of Art

Technology has entered into the health and wellness arena for users by allowing personal monitoring of criteria once only available to sophisticated physicians and/or costly equipment. With the advent of processors, sensors, smartphones, portable devices, and increased connection speeds on the Internet, data collection is feasible and not an economic burden. Personal monitoring using such technology has greatly increased with personal health and wellness being a concern for a long and happy life.

It may be desirable to have a standards based system and method for merging technology with health and/or wellness advice.

### BRIEF DESCRIPTION

In an embodiment, a system is provided that facilitates delivery of information between a treatment provider and a user. The system can include a processor coupled to a memory, the processor configured to execute a computer-executable server component stored in the memory. The server component is configured to receive a health condition defined by a set of parameters, wherein one or more of the set of parameters mitigate the health condition, the server component is further configured to establish a relationship between a treatment provider and a user, wherein the relationship is based on the health condition of the user, the server component receives a kit prescribed by the treatment provider for the user, the kit includes a subset of the set of parameters defined for the health condition of the user, the server component is further configured to communicate a device list for the user based on the kit prescribed, wherein the device list defines one or more devices that collect data representative of one or more of the subset of parameters included in the kit, the server component is further configured to receive data representative of one or more of the subset of parameters included in the kit from at least one device selected by the user, and the server component is further configured to communicate at least one of a health advice, a medical advice, or an adjustment of the kit to the user for further treatment of the health condition.

In an embodiment, a method of delivering advice is provided that includes at least the following steps: employing at least one processor configured to execute computer-executable instructions stored in memory to perform the following acts: establishing a relationship between a user and a treatment provider based on a condition of the user; communicating a set of parameters for the condition to the treatment provider; assigning a subset of the set of parameters to the user; communicating at least one device to the user that collects data representative of one or more of the subset of parameters; collecting data representative of the one or more of the subset of parameters from the at least one device selected by the user; communicating the collected data to the treatment provider; and communicating from the treatment provider to the user, based on the collected data, at least one of a health advice, a medical advice, or an adjustment of the subset of the set of parameters.

In an embodiment, a system is provided that facilitates delivery of information between a treatment provider and a user, in which the system includes at least one of the following: a processor coupled to a memory, the processor configured to execute the following computer-executable components stored in the memory: a server component that is configured to receive a health condition defined by a set of parameters, wherein one or more of the set of parameters mitigate the health condition; the server component is further configured to establish a relationship between a treatment provider and a user, wherein the relationship is based on the health condition of the user and a health insurance policy of the user; the server component receives a kit defined by the treatment provider for the user, the kit includes a subset of the set of parameters for the health condition of the user in which the subset of set of parameters aids in the treatment of the health condition; the server component is further configured to communicate a device list for the user based on the kit prescribed, wherein the device list defines one or more devices that collect data representative of one or more of the subset of parameters included in the kit; the server component is further configured to receive data representative of one or more of the subset of parameters included in the kit from at least one device selected by the user; the server component is further configured to communicate at least one of a health advice, a medical advice, or an adjustment of the kit to the user for further treatment of the health condition; a data exchange component that is configured to create a secure channel to communicate at least one of the kit, the device list, data collected that is representative of one or more subset of parameters defined in the kit, advice based on the data collected, or an adjustment of the kit based on the data collected, wherein the secure channel is created between a user and a treatment provider that have an established relationship to mitigate the health condition; wherein the treatment provider creates the kit for the user and the device list is not communicated to the treatment provider; and wherein the user selects one or more devices from the device list and the subset of the parameters defined in the kit for the user are not communicated to the user.

### BRIEF DESCRIPTION OF THE DRAWINGS

Reference is made to the accompanying drawings in which particular embodiments and further benefits of the invention are illustrated as described in more detail in the description below, in which:

FIG. 1 is an illustration of a system that communicates a user-specific kit of parameters from a set of parameters to mitigate a condition of a user;

FIG. 2 is an illustration of a system that collects data representative of a parameter from one or more networks for generation of health advice or medical advice;

FIG. 3 is an illustration of an embodiment of a system for establishing a secure channel on a network to exchange information between a user and a treatment provider;

FIG. 4 is an illustration of an embodiment of a system for creating a relationship between a user and a treatment provider based on a condition of the user and distributing information there between with a secure channel;

FIG. 5 is an illustration of an embodiment of a system that establishes a respective channel for each condition of a user to exchange data between the user and each respective provider;

FIG. 6 is an illustration of an embodiment of a system that facilitates leveraging data received from one or more secure channels;

FIG. 7A is an illustration of an embodiment of a system that facilitates connecting a device to transmit data representative of a parameter;

FIG. 7B is an illustration of an embodiment of a system that facilitates connecting a device to transmit data representative of a parameter subsequent a connection to a network;

FIG. 8 is an illustration of a flow chart of an embodiment of a method for establishing a secure channel on a network for a treatment provider to transmit medical advice and/or health advice to a user to manage a condition of the user;

FIG. 9 is an illustration of a flow chart of an embodiment of a method for establishing a secure channel on a network for a user to receive medical advice and/or health advice from a treatment provider;

FIG. 10 is an illustration of a flow chart of an embodiment of a method for transmitting data representative of a parameter in order to receive medical advice and/or health advice for a condition of a user;

FIG. 11 is an illustration of a flow chart of an embodiment of a method for receiving data representative of a parameter from a device network specific to a device;

FIG. 12 is an illustration of a flow chart of an embodiment of a method for utilizing manually entered data representative of a parameter in order to receive medical advice and/or health advice;

FIG. 13 is an illustration of a flow chart of an embodiment of a method for selecting one or more devices to collect data representative of one or more parameters designated by a treatment provider;

FIG. 14 is an illustration of a flow chart of an embodiment of a method that facilitates providing medical and/or health advice;

FIG. 15 is an illustration of a flow chart of an embodiment of a method that facilitates providing medical and/or health advice;

FIG. 16 is an illustration of a flow chart of an embodiment of a method that facilitates providing medical and/or health advice;

FIG. 17 is a schematic block diagram illustrating a suitable operating environment for aspects of the subject disclosure;

FIG. 18 is a schematic block diagram illustrating a suitable environment for delivery of data in accordance with the subject disclosure; and

FIG. 19 is a schematic block diagram illustrating illustrates a cloud computing environment in accordance with the subject innovation.

### DETAILED DESCRIPTION

Embodiments of the invention relate to methods and systems for establishing a relationship between a user and a treatment provider to mitigate a condition of the user. A treatment provider can select or define a kit tailored to the user in which the kit defines data (e.g., parameters) that is to be collected and subsequently delivered to the treatment provider. The data delivered to the treatment provider is used to communicate health advice, medical advice, and/or adjustment of the kit of which one or all mitigate the condition of the user. A condition can be defined with a set of parameters, wherein the set of parameters can assist in diagnosing, treating, preventing, and/or healing the condition.

Based upon at least the condition of the user to which a treatment provider has established a relationship, the treatment provider can assign a subset of parameters from a set of parameters defined for the condition. The assignment of the subset of parameters can be tailored to the user by, for example, the treatment provider. Such subset of parameters can be communicated to the user, wherein the user can identify one or more devices or data techniques to collect data representative of the subset of parameters. In an example, the user may be unaware of the subset of parameters assigned such that devices or data techniques are selected and the subset of parameters are not displayed to the user. Such collected data representative of the subset of parameters can further be communicated to the treatment provider to which the user has established a relationship. With the data representative of the subset of parameters, the treatment provider can provide at least one of the health advice, medical advice, and/or adjustment of the subset of parameters to mitigate the condition.

Moreover, embodiments of the invention relate to methods and systems for establishing a secure communication to communicate medical advice and/or health advice to a user having a condition. The secure communication can be established between a treatment provider and a user, wherein the treatment provider is communicating medical advice and/or health advice to manage the condition based on data representative of parameter(s) that can affect the condition. The user can select one or more devices that collect data related to the parameter(s) and the secure channel is used to communicate such data to the treatment provider that is handling the condition to allow for communicating the medical advice and/or health advice.

With reference to the drawings, like reference numerals designate identical or corresponding parts throughout the several views. However, the inclusion of like elements in different views does not mean a given embodiment necessarily includes such elements or that all embodiments of the invention include such elements.

The term “health” as used herein can be defined as a state related to a human being which can include, but not limited to, mental health, physical health, medical health, physical wellness, mental wellness, emotional health, emotional wellness, among others.

The term “kit” is an assigned subset of parameters from a set of parameters defined for a condition, wherein the subset of parameters facilitate providing medical advice, health advice, and/or adjustment of the assigned subset of parameters.

The term “component” as used herein can be defined as a portion of hardware, a portion of software, or a combination thereof. A portion of hardware can include at least a processor and a portion of memory, wherein the memory includes an instruction to execute.

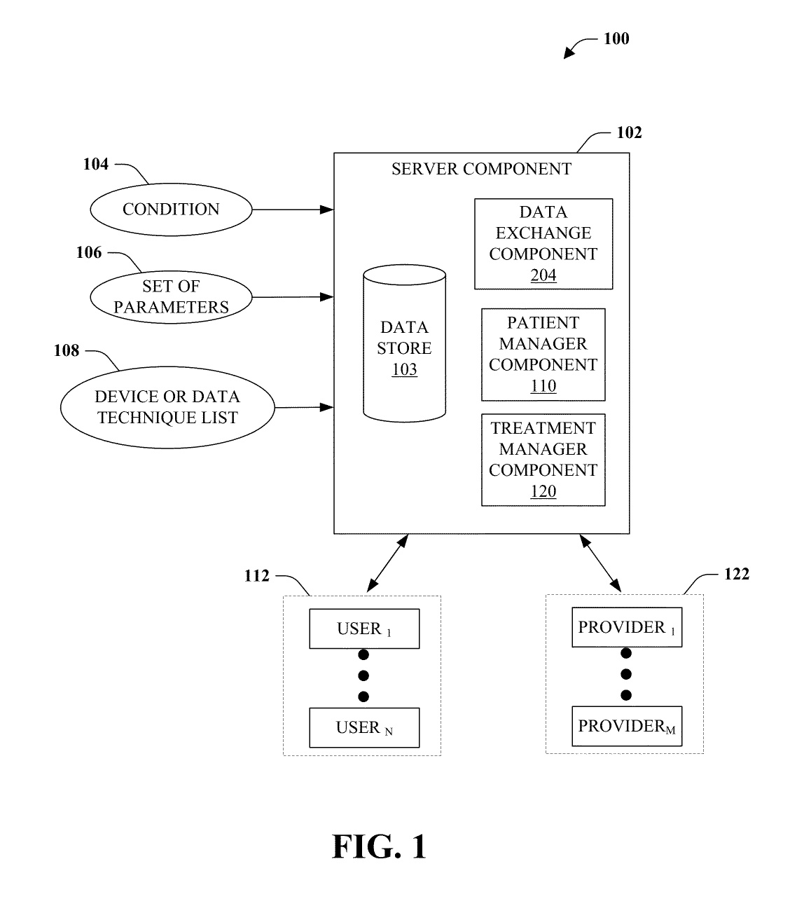

FIG. 1 illustrates a system 100 that facilitates mitigating a health condition based upon information communicated between a user and a treatment provider, wherein a relationship is established between the user and the treatment provider. The system 100 can include a server component 102 that is configured to communicate (e.g., receive and/or transmit) data such as, but not limited to, a condition 104, a set of parameters 106, or a device or data technique list 108. The server component 102 is configured to create relationships between users 112 and treatment providers 122 in order to deliver advice to mitigate a condition of a user. Within an established relationship, a treatment provider can prescribe or define a kit that defines which data to collect from the user to facilitate providing advice and/or treatment to the user for the condition. The server component 102 can communicate (e.g., receive and/or transmit) one or more conditions 104, each having a defined set of parameters used by the treatment provider to treat or better the condition. Moreover, the server component 102 can be configured to translate a kit into one or more devices or data techniques that collect data representative of the one or more subset of parameters (e.g., the kit) from the set of parameters for the condition. Thus, a user can select a device or data technique while being unaware of which data is being collected for what parameter so as to reduce confusion for the user while taking into account privacy concerns. For instance, privacy techniques for data can be utilized with the subject innovation so as to be in compliance of government regulations such as, but not limited to, Health Insurance Portability and Accountability Act (HIPAA), and the like. Similarly, a treatment provider can select the kit and subset of parameters while being unaware of which devices or data techniques are being used by the user so as to reduce confusion for the treatment provider. The server component 102 can be configured to communicate a kit to a user, receive data based on a definition of the kit, and communicate advice to the user based on such received data. Moreover, the server component 102 can be configured to communicate a list of devices or data techniques to collect data for the kit and receive data from one or more devices selected from the list.

The server component 102 can communicate with one or more users 112 and/or one or more treatment providers 122 (also referred to as “providers”). The server component 102 can receive a definition of the condition 104 that indicates to a treatment provider what the condition 104 is and indicates the set of parameters 106 that can mitigate, treat, or affect the condition 104. Moreover, the server component 102 can receive a device or data technique that is generated for each of the parameters such that a parameter is translated to a device or data technique that collects data representative of the parameter.

The server component 102 can further include a data store 103 (discussed in more detail below) that can be configured to store data used with the system 100 (as well as other systems described herein). The data store 103 can be a server, a hard drive, a cloud-storage, a website, a network drive, among others. The data store 103 can host information related to the condition 104, a set of parameters 106 for a condition, device or data technique list 108, user information, treatment provider information, authentication information for a user, authentication information for a treatment provider, translation information that indicates which device collects data for which parameters, data used and/or created by a patient manager component 110, data used and/or created by a treatment manager component 120, data used and/or created by a data exchange component 204, among others. Although a single data store 103 is illustrated, any suitable number of data stores can be used with the system 100. For instance, a first set of data related to users can be stored on a first data store and a second set of data related to treatment providers can be stored on a second data store. The number of data stores and the organization where the data is stored there on can be selected with sound engineering judgment and/or by one skilled in the art without departing from the scope of the subject innovation. It is to be appreciated that the data store 103 can be configured to satisfy and meet regulations and/or requirements described by the Safe Harbor Method defined by HIPPA and/or any other regulation related to data security, privacy, and the like. It is to be understood that any Safe Harbor Method can be chosen with sound engineering judgment and/or by one having ordinary skill in the art without departing from the scope of the subject innovation.

The server component 102 can receive a data package that includes at least one of the condition 104, the set of parameters 106, and/or the device or data technique list 108. It is to be appreciated that the data package can be updated, modified, and the like. For instance, a data package can be tailored to include data for a condition. In another example, a data package can be tailored to include data for an area of practice. In still another example, a data package can be tailored for a treatment provider or a user. In such an example of a user-specific data package, a data package for one or more conditions specific to a user can be hosted in the data store 103 and used in a relationship established with a treatment provider.

In an embodiment, the data package can be programmed and communicated to the server component 102. In a specific embodiment, the data package can be created as a template a treatment provider can modify. For instance, a template data package can include a recommended set of parameters for a condition, wherein the treatment provider can modify such set of parameters (e.g., add, remove, etc.) based on his or her professional determination.

In general, the server component 102 is configured to define a subset of parameters (e.g., also referred to as a kit) from a set of parameters to mitigate, treat, or affect a condition of a user. The defined or prescribed subset of parameters can be tailored to the user based on at least one of the condition and/or a criteria of the user (e.g., age, sex, family history, genetics, among others) (discussed in more detail below). This customized kit for the user defines which data representative of the one or more subset of parameters is to be collected for the particular user. The treatment provider can generate and communicate advice for the user based on the data collected from the kit.

The following is an example that is solely for illustration and is not to be limiting on the subject innovation. By way of example and not limitation, a condition can be defined as “seasonal allergies” in which a set of parameters can be further indicated that can treat, mitigate, or affect (likely alleviate) the seasonal allergies condition. A user and a treatment provider can establish a relationship, wherein the relationship is to allow the user to receive advice from the treatment provider for the condition. The treatment provider can review the set of parameters for the condition (here, seasonal allergies). The treatment provider can further select or prescribe a subset of the set of parameters specifically for the user, wherein the subset is selected not only based on the condition of the user but additional criteria or factors (as the treatment provider deems necessary). This subset of parameters is translated to a list of devices or data techniques that are capable of collecting information representative of one or more of the subset of parameters. After data is collected, the treatment provider receives data representative of one or more of the subset of parameters and can provide advice to the user, wherein the advice mitigates, treats, or affects the condition.

In an embodiment, a treatment provider can create a “treatment provider defined parameter” that can be added into a kit such that the treatment provider defined parameter is added to the set of parameters that can be selected for a user having a condition. This embodiment allows for customization of the treatment of the condition for the user rather than being limited to a set of parameters defined for the condition. It is to be appreciated that this embodiment can be secluded to a study, clinical study, and the like for the condition in which to measure the impact of the “treatment provider defined parameter” used with the kit.

It is to be appreciated that the server component 102 can include the following components as integrated components: patient manager component 110; the treatment manager component 120; the data exchange component 204; and the data store 103. However, it is to be appreciated that each component can be a stand-alone component, incorporated into the server component 102 (as depicted), or a combination thereof. Moreover, it is to be appreciated that any suitable technique can be used to communicate data collected that is representative of parameters defined in a kit and the subject innovation is not limited to a particular technique.

It is to be appreciated that a manner in which the network collects the one or more parameters can be compliant with privacy and/or security techniques to ensure transmission and/or receipt of data. For instance, privacy techniques for data can be utilized with the subject innovation so as to be in compliance of government regulations such as, but not limited to, Health Insurance Portability and Accountability Act (HIPAA), and the like. Security and/or privacy techniques can be chosen with sound engineering judgment and/or by one having ordinary skill in the art without departing from the scope of the subject innovation. It is to be appreciated that a secure channel as used herein can be at least in compliance with the U.S. law defined by the Health Insurance Portability and Accountability Act or U.S. law governing or equivalent thereof, and/or any other regulation related to privacy, security, and the like.

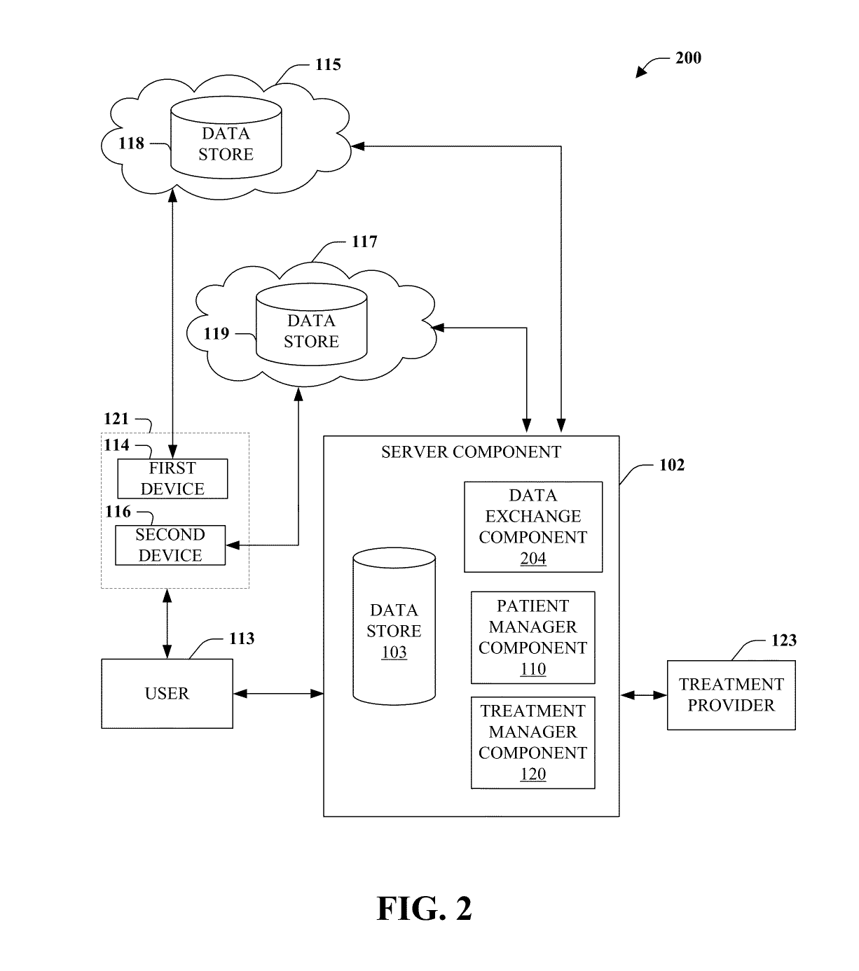

FIG. 2 illustrates a system 200 for collecting data representative of a kit defined for a specific user to facilitate communicating advice for a condition of the specific user. The system 200 is an example and is not to be limiting on the subject innovation. For example, the system 200 illustrates a relationship between a user 113 and a treatment provider 123. Yet, the server component 102 can manage a plurality of relationships between various users and treatment providers. For instance, system 200 illustrates a first device 114 and a second device 116 that collect data representative of one or more subset of parameters defined in a kit for a user. However, it is to be appreciated that any suitable number of devices can be used to collect data for a personalized kit and that any suitable number of parameters can be included with such personalized kit. Moreover, the illustration of communicating the data collected includes use of device-specific networks and/or data stores (e.g., device network 115, data store 118, device network 117, and data store 119). However, the subject innovation is not to be limited on the manner in which data collected based on a kit is communicated to the server component 102. Further, the data collection based on a kit is illustrated by reference numeral 121. It is to be appreciated that any suitable number of devices and/or networks can be used to collect data from the one or more devices (e.g., here illustrated as first device 114 and second device 116). For instance, a smartphone can be used to communicate with the first device 114 and/or the second device 116 for data delivery (e.g., here delivery to the device network and subsequently/simultaneously to the server component 102).

The server component 102 can facilitate establishing a relationship between the treatment provider 123 and the user 113 based on at least a condition of the user 113, wherein the relationship is formed to treat, advice, or mitigate the condition. The treatment provider 123 can select a subset of parameters from a set of parameters defined for the condition to create a customized kit for the user. The kit can be created by the treatment provider 123 to treat, advice, or mitigate the condition of the user based on data collected via the kit. For instance, the subset of parameters can be based on a professional determination of the treatment provider and/or a diagnosis. Moreover, the kit can be selected based on additional criteria or information about the user. Upon selection of the kit, a device or data technique list is created. The kit defines what data is to be collected and the list defines what devices or data techniques can be used for the subset of parameters defined in the kit. The kit and the list are used to enable the treatment provider 123 to treat, advice, mitigate the condition of the user 113. In still another embodiment, the data collected due to the kit and the list for the relationship can be used to adjust the kit.

The server component 102 can receive a kit selected for the user 113 by the treatment provider 123. The kit can be communicated to the user 113. The user 113 can receive a list of devices and/or data techniques that can collect data representative of the defined subset of parameters. The collected data (e.g., representative of the defined subset of parameters) can be communicated to the server component 102 and/or the treatment provider 123. The treatment provider 123 can provide advice and/or adjustment to the kit for the user based on the received collected data. It is to be appreciated that the treatment provider 123 can provide the advice and/or adjustment to the kit by electronic communication, hard copy communication, verbal communication, and/or a combination thereof.

Upon receipt of the list from the server component 102, the user 113 can select one or more devices to collect data representative of the subset of parameters as defined in the kit for his or her condition. In this example, the user 113 selects the first device 114 and the second device 116, wherein the first device 114 uses the device specific network 115 with the data store 118 and the second device 116 uses the device specific network 117 with the data store 119). An authentication (e.g., username, password, credentials, etc.) can be used by the user to allow the first device 114 to communicate with at least one of the device specific network 115 or the data store 118. Similarly, an authentication can be used by the user to allow the second device 116 to communicate with at least one of the device specific network 117 or the data store 119.

The authentication for each device and respective device specific network can be utilized by the server component 102 to collect data defined by the kit. It is to be appreciated that the data collection via the authentication can be used regardless of when synchronization of the first device 114 or the second device 116 occurs. Thus, the server component 102 can collect data defined by the kit from the data store 118 or the data store 119 at a point in time before, during, and/or after a synchronization or data upload from the first device 114 or the second device 116.

The data communications from reference numeral 121 to the respective device specific networks can be directly from the first device 114 or the second device 116 (as depicted). In another example, the data communications from reference numeral 121 can be through an additional computing device such as, for instance, a computer, a smartphone, a laptop, a tablet, and the like. In such example, the first device can be connected to the additional device and the additional device can communicate data to the device specific network and/or the server component 102.

The data representative of parameters defined by the kit for the user 113 can be received by the server component 102. The treatment provider 123 can evaluate the data collected and generate at least one of advice or an adjustment of the kit in order to mitigate the condition of the user. In another embodiment, at least one of advice or adjustment of the kit can be from the treatment provider 123 that has established a relationship with the user 113 and an additional treatment provider (not shown), wherein the user 113 can give consent to the additional treatment provider. In still another embodiment, at least one of advice or adjustment of the kit can be from a group, a board, a counsel, an organization, a network of professionals, and the like.

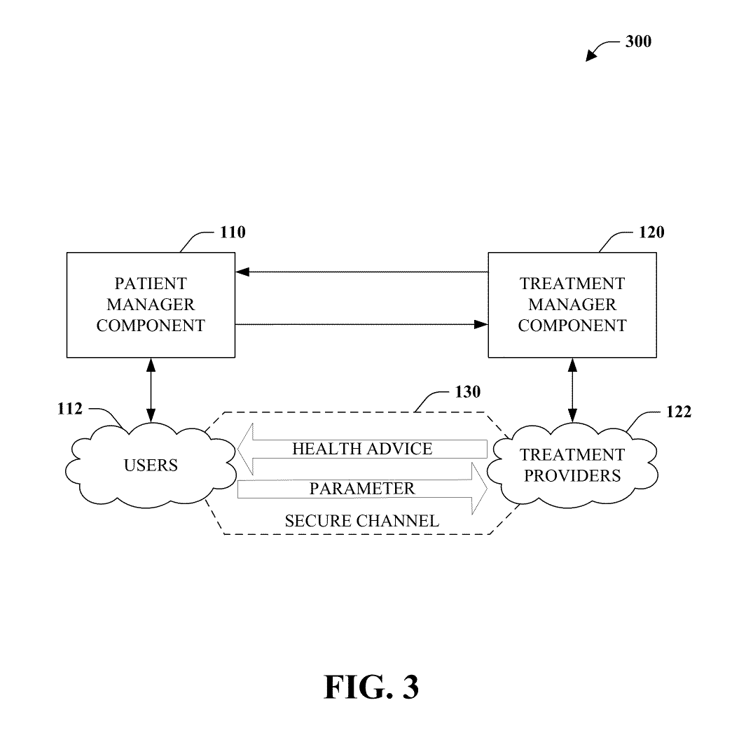

FIG. 3 illustrates a system 300 for establishing a secure channel on a network to exchange information between a user and a treatment provider based on a condition of the user. The system 300 can include a patient manager component 110 that is configured to receive and/or transmit information with one or more users 112 and a treatment manager component 120. The treatment manager component 120 can be configured to receive and/or transmit information between one or more treatment providers 122 and the patient manager component 110.

It is to be appreciated that the data exchange and information flowing between the patient manager component 110 and the treatment manager component 120 can be a network, wherein the network is at least one of a website, a server, a computer, a cloud-service, a processor and memory, or a computing device connected to the Internet. In general, the network can be coupled to one or more devices via wired or wireless connectivity in which data communications are enabled between the network and at least one of a second network, a subnetwork of the network, or a combination thereof. For instance, a user can communicate data from a first network and the Internet (a second network) that provides a connection to communicate data to a treatment provider (hosted by a third network), wherein the first network, the second network, and the third network provide data communications between the user and the treatment provider. It is to be appreciated that any suitable number of networks can be used with the subject innovation and data communication on networks can be selected by one of sound engineering judgment and/or one skilled in the art. By way of example, each treatment provider can be hosted by one or more networks (collectively referred to as first networks) and each user can be hosted by one or more networks (collectively referred to as second networks), wherein data communications between the first networks and the second networks can be hosted by or performed on the Internet (e.g., another network), a third network, and the like. Moreover, any suitable number of devices can be used on the one or more networks to communicate data over the one or more networks.

The patient manager component 110 can communicate data from one or more users 112 to the treatment manager component 120 via, for example, one or more networks, devices, and the like. For instance, a user can communicate (e.g., receive and/or transmit data) to the treatment manager component 120 with a smartphone or a computing device over a network. Further, the patient manager component 110 can receive data from the treatment manager component 120 and deliver such data to the one or more users 112 via, for example, one or more networks, devices, and the like. By way of example and not limitation, the data communicated between the patient manager component 110 and the treatment manager component can be related to at least one of establishing a relationship, health advice, medical advice, wellness advice, request for treatment, a condition of a user, one or more parameters, data representative of a parameter, user information, payment information, and the like. For instance, each user 112 can be authenticated for access to the network with the communications between the patient manager component 110 and the treatment manager component 120. In an example of how a condition of a user is determined or defined, the patient manager 110 can receive a condition from a user (e.g., the condition being referred to as “user-defined” since being defined by the user), wherein one or more treatment providers 122 utilize the subject innovation to mitigate the condition. In a similar example of defining a condition of one of the users 112, one of the treatment providers 122 can assign or diagnose a condition to one of the users 112 based on an earlier or previous prognosis (e.g., the condition being referred to as “treatment provider defined” since being defined by the treatment provider), wherein such definition of a condition is communicated between the treatment manager component 120 and the patient manager component 110 (discussed in more detail below).

The patient manager component 110 and the treatment manager component 120 can communicate data in order to establish a relationship between a user and a treatment provider, wherein the relationship can be requested by the user or the treatment provider and accepted by the user or the treatment provider. In another non-limiting embodiment, the request can be mutually communicated by the user and the treatment provider and/or the acceptance can be mutually communicated by the user and the treatment provider. In the example of one of the users 112 requesting advice from one or more treatment providers 122 for a condition of the one user (e.g., user submitting a request to establish relationship with a treatment provider), the treatment manager component 120 can receive the condition of the user from the patient manager component 110 and identify one or more treatment providers 122 that manage the condition. Whether a treatment provider 122 is capable of handling, treating, or managing the condition can be determined by one of the treatment providers 122 themselves, a third-party, a criteria (e.g., a verification, a degree of schooling, a verification request monitored by a third-party entity, an administration, a health insurance coverage, a medical facility, an employee of an insurance company, an employee of a hospital, etc.), an administrator of the patient manager component 110, an administrator of the treatment manager component 120, an administrator of the system 300, and the like. The list of treatment providers 122 can be presented to the user (e.g., list communicated from the treatment manager component 120 to the patient manager component 110 and in turn to the one or more users 112) via the patient manager component 110. The user that submitted the request for advice on his or her condition can select one treatment provider 122 to request to electronically interact with the selected treatment provider 122 for the treatment of the condition.

It is to be appreciated that in a non-limiting embodiment, the user can submit a request for more than one treatment provider 122 but only a single treatment provider can accept the request from a user such that a relationship between a user and a treatment provider for each condition is at least a one-to-one ratio. For example, a user can have multiple conditions handled by a single treatment provider. In another non-limiting example, a user may not have a condition handled by more than one treatment provider. It is to be appreciated that in another embodiment, the user can submit a request for more than one treatment provider 122 and more than one treatment provider can accept the request and a user to a treatment provider relationship for each condition is greater than a one-to-one ratio. The following examples are depicted with a one-to-one ratio between a user and a treatment provider, wherein the treatment provider is the sole entity (e.g., person, company, group, business, and the like) for handling the specific condition of the user.

Still following the example of one of the users 112 requesting advice from one or more treatment providers 122 for a condition of the one user (e.g., user submitting a request to establish relationship with a treatment provider), the patient manager component 110 can receive a selection from the user of one or more treatment providers and communicate such selection to the treatment manager component 120. The treatment manager component 120 can receive the selection of the treatment providers and communicate such request to each treatment provider. A relationship between a user and a treatment provider based on a condition of the user can be established upon the treatment provider accepting the request and communicating the acceptance to the user. In this embodiment, this one-way acceptance assures that the treatment provider is knowingly entering into a relationship in which advice (e.g., medical advice and/or health advice) will be given to a user. As discussed above, health advice can be any information that relates to at least one of mental health, physical health, physical wellness, mental wellness, emotional health, emotional wellness, among others. Medical advice can be any information that relates to the medical well-being of a human being. The acceptance can be communicated from the treatment provider to the treatment manager component 120 and then to patient manager component 110 and then to the user. It is to be appreciated that the routing of data (e.g., requests, acceptance, and the like) can be routed through the patient manager component 110 and the treatment manager component 120 or through an established communication channel that is secure (discussed in more detail below).

In another embodiment, a treatment provider can establish a relationship with a user via the treatment manager component 120 and, in turn, the patient manager component 110. The relationship created or requested by one of the treatment provider or the user. For instance, a user can define criteria to which one or more treatment providers can apply in order to establish a relationship with said user, wherein the user provides a selection of a treatment provider and the treatment provider accepts such selection (along with the relationship). By way of example and not limitation, the criteria can be a condition of the user, a price range, a geographic location, a referral, an invitation, an insurance coverage, a hospital affiliation, a previous relationship with the treatment provider, an area of practice of the treatment provider (e.g., conditions, education, specialty, expertise, and the like), among others. In another example, the relationship can be established based on a request from the treatment provider to the user, wherein the request is based on a previous or on-going relationship (e.g., appointment, treatment, advice, checkup, diagnosis, and the like). Following this example, a treatment provider may have had an appointment with a user and such relationship can be used to establish a relationship over a network to provide health advice and/or medical advice. It is to be appreciated that the request can be initiated from either the user or the treatment provider. However, in a particular embodiment, a treatment provider accepts whether to establish the relationship in order to preserve whether a treatment provider and user relationship has been created. It is to be appreciated that the communication of data between the treatment provider and the user can be handled by the treatment manager component 120 and/or the patient manager component 110.

Upon acceptance of a request to establish a relationship between a user and a treatment provider, health advice and/or medical advice can be communicated from the treatment provider to the user, wherein the communication of health advice and/or medical advice can be based upon at least one of a condition of the user, a parameter related to the condition, data representative of the parameter, among others. For instance, a condition can be defined to have a set of parameters that can be used by a treatment provider to identify health advice and/or medical advice, wherein such health advice and/or medical advice can be tailored to a user by selection of a subset of the parameters. In general, a treatment provider can prescribe or identify a subset of the set of parameters for a particular user having a condition (e.g., the condition to which the set of parameters are associated). The user can then identify a device or data technique that collects the subset of parameters. This collection of the subset of parameters (e.g., in which the collection can also be data representative of the subset of parameters) can be communicated to the treatment provider. The treatment provider can then provide health advice and/or medical advice based on the specific subset of parameters prescribed or identified for the user.

A condition can be defined with a set of parameters that facilitate caring for the user having such condition, wherein the caring can include treatment, diagnosing, checkup, monitoring, and the like. The set of parameters can then be selected and assigned to a user by a treatment provider based on the established relationship. It is to be appreciated that the treatment provider can select and assign a subset of the parameters based on criteria specific to the user to create a kit. Thus, a subset of parameters can be prescribed or assigned to a user not only based on his or her condition, but information related to the particular user. By way of example and not limitation, the information related to the particular user can be at least one of family history, medical history, previous health conditions, DNA, genetics, genetic makeup, genetic sequencing, health statistics, age, sex, an amount of exercise, a body fat percentage, a lifestyle type (e.g., athletic, obese, alcoholic, vegetarian, vegan, and the like), a diet, a food intake, geographic location, heart rate, blood pressure, cholesterol, a disease, a diagnosis of a health condition other than the condition to which the relationship is established, a characteristic that has shown to impact the condition to which the relationship is established, among others.

It is to be appreciated that in an embodiment, the one or more parameters can be data representative of a parameter. Such parameters can be collected via a device used by the user and communicated to the treatment provider through a secure channel 130. In another example, the parameters can be collected via a data technique such as manual entry via a device. In still another example, the parameters can be communicated via a device network that is associated with a particular device that the user uses.

The treatment provider can define the one or more parameters without concern of which device or data technique the user will use to collect such parameter(s) or information representative of parameter(s). In other words, the collection of the one or more parameters, according to the treatment provider, is device agnostic and/or data technique agnostic. The treatment provider is not concerned or aware of which device or data technique is collecting the one or more parameters and only that the one or more parameters are being collected for the user and the condition. The treatment provider assigns the subset of parameters for the user and his or her condition, and receives the subset of parameters (and data representative of the subset of parameters) to be used to generate health advice and/or medical advice.

The subset of parameters identified by the treatment provider for the specific user and his or her condition can further correspond to one or more devices or data techniques to collect data representative of the subset of parameters. In an embodiment, the user can receive the subset of parameters assigned from the treatment provider, one or more devices that collect data representative of one or more of the subset of parameters, or one or more data techniques that collect data representative of one or more of the subset of parameters. In a particular non-limiting embodiment, devices or data techniques can be provided to the user for selection to which the user is unaware of the subset of parameters (or data representative of the subset of parameters) that are being collected. This unaware collection can be referred to as parameter agnostic. In such an embodiment, the user can select a device or data technique that is available to him or her which collects the subset of parameters or data representative of the subset of parameters without explicitly knowing the subset of parameters assigned to him or her by the treatment provider.

Based on the condition specified by the user, a set of parameters can be defined for the condition, wherein a subset of the set of parameters can be assigned by the treatment provider to the user. In an embodiment, the set of parameters for each condition can be pre-defined, dynamically defined, or a combination thereof. Moreover, conditions can be pre-defined, dynamically defined, or a combination thereof. FIGS. 1-2 describe this in more detail. The treatment provider can select which subset of the set of parameters should be collected and monitored for the condition and such listing of the subset of parameters is communicated to the user. Based on the relationship being established, the secure channel is created 130. The secure channel 130 can be used to communicate the list of the one or more parameters from the treatment provider to the user. In another embodiment, the treatment manager component 120 can communicate the list of the one or more parameters to the patient manager component 110 and/or the user. It is to be appreciated that the secure channel 130 can be established and used during any communication between a user and a treatment provider. Moreover, for a communication of data, one or more secure channels 130 can be used for each relationship. For instance, a first communication of data can use a first secure channel for a relationship (e.g., between a user and a treatment provider for at least one condition) and a second communication of data can use a second secure channel for the relationship. Furthermore, the secure channel 130 can be hosted by one or more networks (as discussed above). The secure channel 130 can provide a secure communication of data regardless of the physical connection path, wherein the connection path can be between two or more of a network associated with the patient manager component 110, a network associated with a user, a network associated with a device, a network associated with the treatment manager component 120, a network associated with a treatment provider, a parameter collection device network, the Internet, a computing device, a server, a hard drive, a processor, a memory, a cellular network, a LAN, a wireless network, a wired network, a WLAN, a network that communicates data, and the like.

As discussed above, the patient manager component 110 can communicate a subset of parameters selected and defined by a treatment provider to a user based on the established relationship. Moreover, the patient manager component 110 may communicate the subset of parameters directly or indirectly. For instance, a direct communication can make the user aware of the subset of parameters assigned by the treatment provider. In another instance, an indirect communication can make the user unaware of the subset of parameters assigned by the treatment provider. For instance, rather than communicating the subset of parameters assigned, the patient manager component 110 can provide options to collect the subset of parameters or data representative of the subset of parameters. In other words, the patient manager component 110 can provide one or more devices or data techniques to collect data in accordance with the assigned subset of parameters for the user. The user can select which devices or data techniques he or she wants to utilize to collect the subset of parameters or data representative of the subset of parameters. Upon selection of device(s) or data technique(s), the patient manager component 110 can utilize such selection(s) to obtain and communicate information to the treatment manager component 120 (and further to the treatment provider that has an established relationship with the user).

Upon receiving the list of the one or more parameters (e.g., a kit or subset of parameters) defined or assigned by the treatment provider, the user can select devices or data techniques to collect information corresponding to the subset of parameters. For instance, the user can select at least one of a) one or more devices that will collect data representative of assigned subset of parameters or the subset of parameters; or b) a data technique (e.g., data entry, data transmission, data communication, etc.) to submit data representative of the subset of parameters or the subset of parameters. In an embodiment, the device selection can be parameter agnostic, wherein the user does not know or is not concerned about which parameter is being collected. In another embodiment, each parameter has a corresponding list of devices that can be used to collect such parameter (e.g., the user knows or is concerned about which parameter is being collected). For instance, a corresponding list of devices for each parameter for each condition can be defined by, but is not limited to, the network, an entity, a third-party, among others (discussed in FIGS. 1-2).

The data technique or the device can be selected with sound engineering judgment and/or by one skilled in the art. One or more devices can collect data for one or more of the subset of parameters. One or more data technique can collect data for one or more of the subset of parameters. In another example, one device can collect data for one parameter of the subset of parameters. In still another example, one device can collect data for two or more parameters of the subset of parameters.

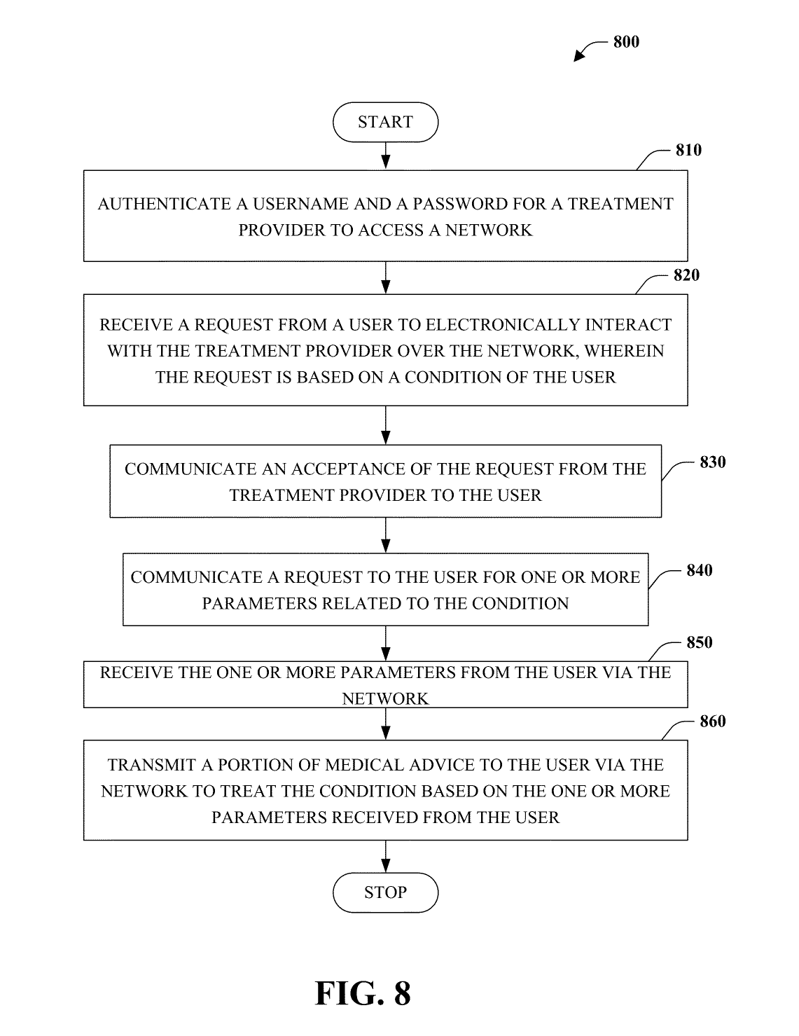

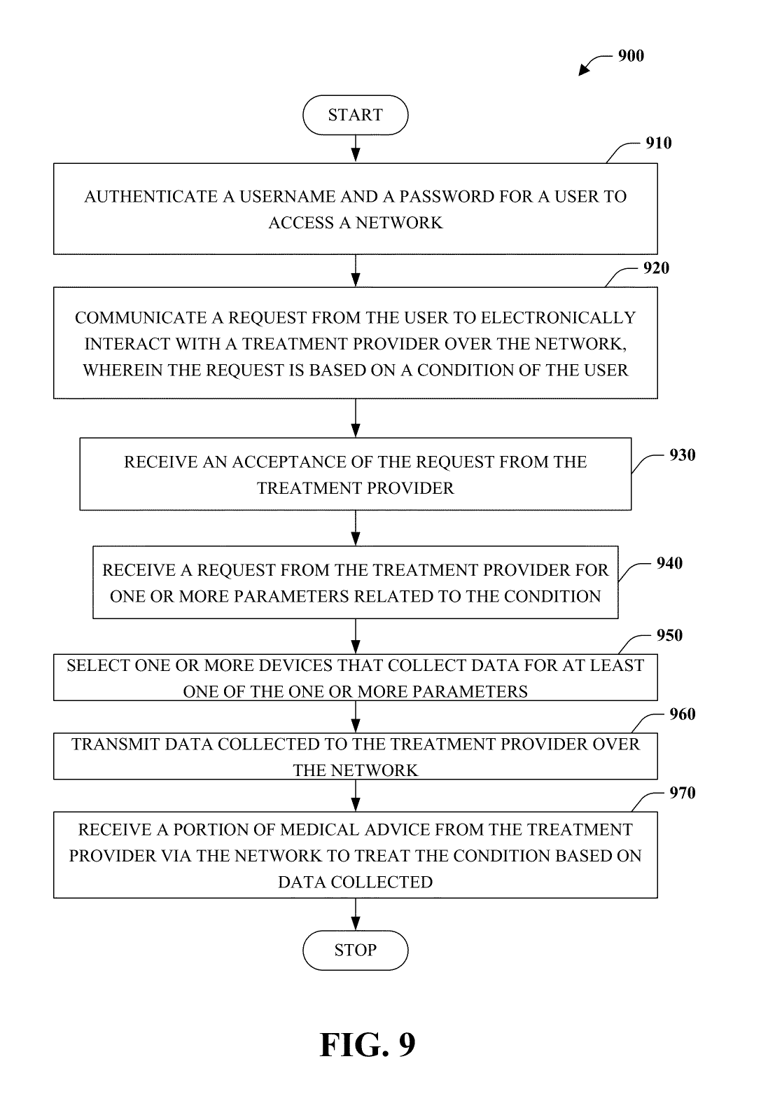

The user can select one or more devices to collect data representative of the one or more parameters (e.g., kit or subset of parameters). The data collected can be communicated to the treatment provider, wherein the communication of the data is handled by the secure channel 130. For instance, a specific device can collect information specific to a particular parameter. In another instance, a device can collect information for more than one parameter. In another instance, multiple devices can collect information for one or more parameters. The selection of the one or more devices can also include a connectivity of the one or more devices to transmit data collected (discussed in FIGS. 8-9).

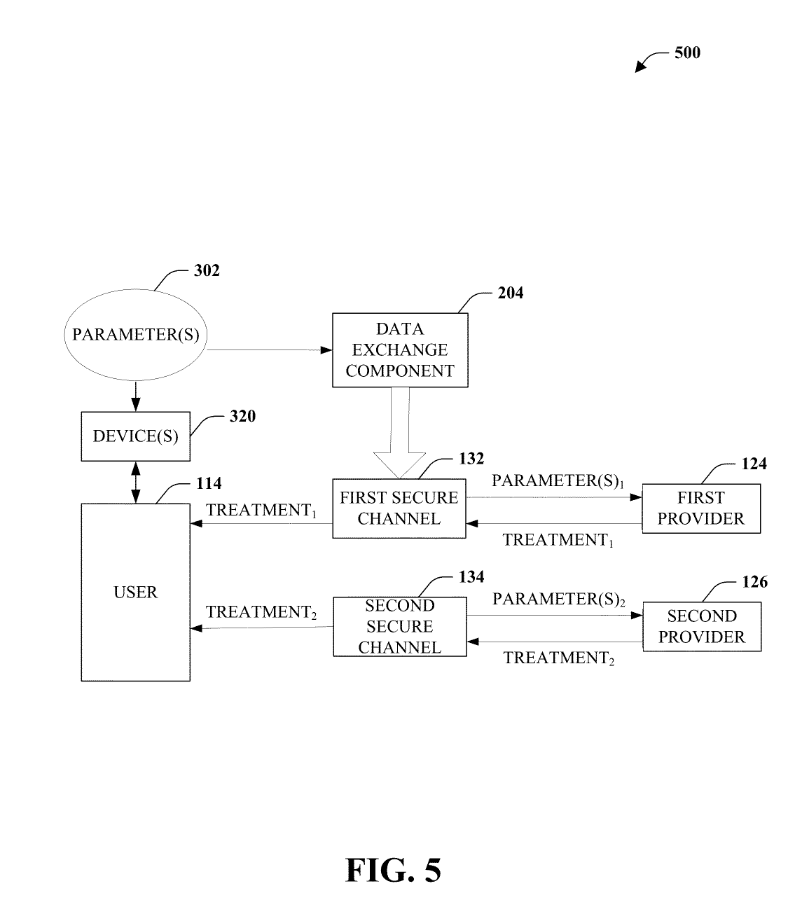

As illustrated in more detail in FIGS. 5A and 5B, one or more devices can collect data representative of the subset of parameters and such data can be communicated to the treatment provider to which the user has established a relationship. In an example, the communication of the data from the device to the treatment provider and/or the treatment manager component 120 can be a) from the device; b) from a computing device that connects to the device; c) from a device network (e.g., server, website, application, cloud-storage, and the like) that hosts data collected by the device; d) manually entered by the user. In one example, the user can supply credentials or provide authorization to pull data from the device network (that is specific to the device). In such example, the treatment manager component 120 authenticates a backend (e.g., the device network) via OAUTH (e.g., or any other standards based authentication method) in order to pull data. It is to be appreciated that “OAUTH” is used solely for example and any standards based authentication method can be selected by one having ordinary skill in the art without departing from the scope of the subject innovation. Such authorization can continue to allow data pull until the credentials expire or the user terminates authorization. It is to be appreciated that the treatment manager component 120 and/or the system 300 can be a middleware that pulls data from a device network for each device and can store, move, copy, and/or share such pulled data to utilize with the treatment providers that have established relationships with the user.

The user can select one or more data entry techniques. For instance, the data entry technique can be a manual entry, wherein the user manually enters data via a device and such data is communicated to the treatment provider within the secure channel 130. In another example, the data entry technique can be an automated entry via a device. For instance, a scheduled data transmission can be provided with the device, wherein data is transmitted with the secure channel 130. In another example, a user can automatically transmit data to the treatment provider upon connecting the device to a computer, connecting the device to an additional device with an Internet connection (e.g., connecting the device to a laptop), connecting the device to the Internet, connecting the device to a device network for data synchronizing, synchronizing the device to a device network, pushing data from the device to the device network, or the user initiating a data synchronization of the device.

The secure channel 130 is a communication channel on the network that allows for at least the collected parameters (e.g., based upon the kit or subset of parameters assigned by the treatment provider) to be communicated to the treatment provider and a treatment for the condition of the user to be communicated to the user, wherein the treatment is based upon the collected data representative of the subset of parameters. It is to be appreciated that the secure channel 130 can be established based on a) a treatment provider's acceptance of the relationship, and/or b) whether the condition of the user falls within a skill set and/or expertise of the treatment provider. In other words, the secure channel 130 can be established based on acceptance of a relationship between a user and a treatment provider, wherein the relationship is established for the treatment provider to provide health advice and/or medical advice to mitigate or better a condition of the user. The secure channel 130 can be used to transmit data (e.g., treatment, advice, parameter(s), data representative of a parameter, etc.) between the user and the treatment provider over one or more networks. Still, the one or more secure channel 130 is exclusive to the relationship established between the user and the treatment provider for information exchange, wherein the exchange of information is authorized with acceptance of a relationship and such relationship is for the treatment provider to communicate health advice and/or medical advice to better a condition of the user. The one or more secure channel 130 is further used to communicate information (e.g., kit, subset of parameters, data representative of parameters, among others). In particular, the one or more secure channel 130 is used to communicate data representative of the subset of parameters to the treatment provider, wherein the treatment provider can provide at least one of health advice, medical advice, or further assignment of a subset of parameters in order to mitigate the condition of the user. In an embodiment, the health advice and/or medical advice can be communicated from the treatment provider to the user via a communication, wherein the communication can be at least one of a hard copy communication (e.g., a letter, a note, and the like), an electronic communication (e.g., email, text, SMS, telephone call, cell phone call, a voicemail, an automated telecommunication, chat, live chat, real time video, video, audio, via a computer, via a computing device, a display, and the like), a physical communication (e.g., in-person meeting, appointment, and the like), a combination thereof, among others.

In an embodiment, a type of communication can be approved by the treatment provider and/or the user. In an embodiment, the communication can be, but is not limited to, an email, a text, a telecommunication, a message, a short-message-service, an electronic message, an audio file, a real-time video communication, a communication via the Internet, and the like. In other words, the communication of health advice and/or medical advice to the user from the treatment provider can be communicated with one or more networks. In another embodiment, the medical advice and/or health advice can be transmitted by a communication outside the network used for the collection of data representative of the subset of parameters. Yet, it is to be appreciated that the communication can be provided within the network used for the collection of data representative of the subset of parameters.

It is to be appreciated that more than one secure channel 130 can be utilized for the relationship between a user and a treatment provider. It is to be further appreciated that the secure channel 130 can be utilized more than once and/or more than one secure channel 130 can be open, used, and/or closed. In an embodiment, a first secure channel can be used for a first relationship between a user and a treatment provider at a first date and/or time and a second secure channel can be used for the first relationship between the user and the treatment provider at a second date and/or time. In another embodiment, a secure channel can be used for a relationship between a user and a treatment provider at a first date and/or time and the secure channel can be used for the relationship between the user and the treatment provider at a second date and/or time, wherein the secure channel 130 is open or has a static Internet Protocol (IP) address. In another example, the secure channel 130 is open, used, and closed depending on whether a communication is performed, wherein the secure channel has a dynamic IP address.

The treatment provider can be, but is not limited to, at least one of a board certified physician, a doctor, a physical therapist, a personal trainer, a dietitian, a fitness professional, a nutritionist, a weight trainer, a medical doctor, a fitness personality from a movie or television, a fitness celebrity, a celebrity, a spokesman or representative for a diet plan, a spokesman or representative for a gym, a spokesman or representative for a workout facility, a spokesman or representative for a workout equipment or workout equipment manufacturer or distributor, a person that offers health advice for financial gain, a person that offers medical advice as a profession, a person that offers medical advice for financial gain, a counselor, an advisor on fitness, an advisor on health, an advisor on mental health, a nurse, a professional with significant knowledge of the condition to provide advice, a person with knowledge of the condition, among others. In general, the treatment provider can be any entity (e.g., person, company, business, third-party, group, organization, union, group of people, etc.) that can provide a treatment and/or medical advice and/or health advice to a user having a condition in which the treatment, medical advice, or health advice is to maintain or improve such condition of the user.

In an embodiment, the condition is at least one of a condition related to the respiratory system of the user, such as asthma, Chronic Obstructive Pulmonary Disease (COPD), an allergy, smoking cessation, a condition related to the cardiovascular system of the user, such as hypertension, arrhythmias, ischemic cardiac disease, a condition related to other physiological systems of the user, such as diabetes, renal failure, a psychological disorders, a condition that requires a scheduled activity, such as rehabilitation of a muscle, rehabilitation of a body part, physical therapy for a portion of a body of the user, a dermatological condition, a terminal illness, a pain management regimen, a substance abuse treatment, an injury, a burn, among others. In general, the condition can be any suitable state of a user that can be improved or maintained by a treatment from a treatment provider.

In an embodiment, the condition is overweight, the portion of health advice is a weight loss plan, and the one or more parameters is at least one of a calorie intake, a fat content intake, a measurement of activity, or a weight management related biometric reading of the user. In an embodiment, the condition is strength training, the portion of advice (e.g., medical advice and/or health advice) is a workout plan, and the one or more parameters is at least one of a calorie intake, a fat content intake, a protein intake, a carbohydrate intake, a measurement of activity, a vital sign, a weight of the user, a progress of an exercise routine, genetic sequencing, genetic makeup, DNA data, analysis of DNA, family history, medical history, or a biological parameter of the user.

In an example, the treatment provider can be an acupuncturist who specializes in fertility, wherein one or more parameters assigned (e.g., kit or subset of parameters) can be basal temperature to know what the ovulation cycle looks like. This can allow the treatment provider to provide health advice and/or medical advice based on the data collected from the subset of parameters assigned.

By way of example and not limitation, the one or more parameters is at least one of an intake of medicine, an application of medicine, a participation of physical therapy, a biological parameter, a vital sign reading (e.g., heart rate, perspiration, temperature, blood pressure, breathing, an EKG signal, etc.), genetic sequencing, genetic makeup, DNA data, analysis of DNA, family history, medical history, a manual input from the user indicating a desire (e.g., urge, craving, and the like), a manual input from the user indicating a receipt of a medication, a manual input from the user related to performing a doctor's instruction, among others. In general, the parameter can be any data the treatment provider identifies that facilitates evaluating the condition of the user in order to provide health advice and/or medical advice to mitigate the condition of the user.

The device can be, but is not limited to, a computer (e.g., desktop computer, laptop, etc.), a smartphone, a tablet, a gaming device, a portable gaming device, a pedometer, a device that monitors or tracks a biological parameter, a device that monitors or tracks a vital sign, a weight scale with a network connection, a wireless device, an RFID device, an NFC device, a Bluetooth device, a heart monitor, a wearable device with a network connection, a device that collects a biological parameter that communicates the biological parameter via the Internet, a device with an input for manual data entry, a wearable fitness device, a wearable device that monitors or tracks a physical activity, a wearable device that monitors or tracks a vital sign, a wearable device that receives a manual user input (e.g., a button press, a keyboard entry, a voice command, a movement or gesture, among others), a device that collects information related to a user's health, a device that collects information related to a user's mental state, an activity device, a breath device, a nutrition device, a blood device (e.g., a device that evaluates a portion of human blood, etc.), a body device (e.g., weight scale, smart scale, etc.), a device that tracks medication intake or application, a device or system that provides a genetic composition, a device that tracks inhaler usage, a device that tracks an opening of a medication bottle, among others.

Data collected by the device can be representative of the one or more parameters (e.g., the kit or the subset of parameters assigned by the treatment provider to which the user has established a relationship). By way of example and not limitation, the parameter can be an activity of the user (e.g., exercise, steps walked, movement, etc.), a food intake of the user (e.g., diet, food consumed, etc.), a medicinal intake of the user (e.g., prescription use, medicine application, medicine intake, adhering to treatment, etc.), a habit of the user (e.g., sleep, exercise, meals, etc.), a mood of the user, a feeling of the user, a craving of the user, an urge of the user, a geographic location of the user, an environmental condition of the user (e.g., temperature, pollen count, time of day, humidity, etc.), a biometric reading related to the user (e.g., heart rate, blood pressure, glucose level, breathing, body temperature, perspiration, etc.), a parameter that the treatment provider determines can mitigate the condition, among others.

It is to be appreciated that any component from system 300 can be a stand-alone component, a sub-component, an integrated component with another component, a system described in another Figure (e.g., system 100, system 200, system 400, system 500, system 600, system 700, system 1700, and the like), and/or a combination thereof. Thus, functionality described in system 300 can be performed by any number of the components discussed.

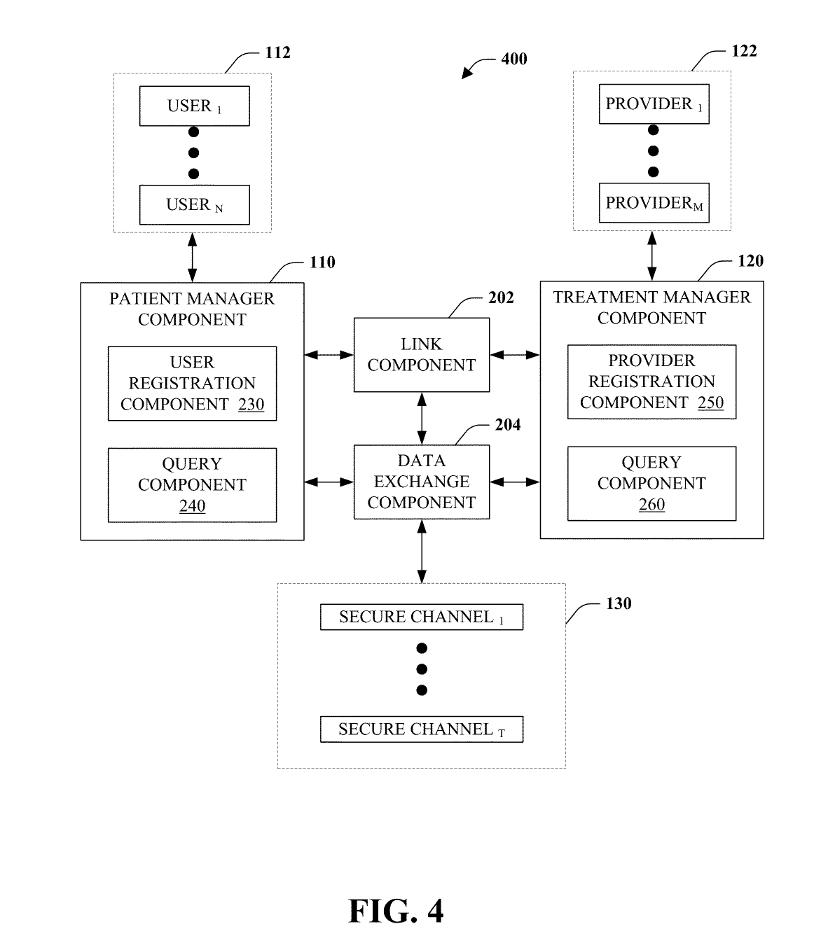

FIG. 4 illustrates a system 400 for creating a relationship between a user and a treatment provider based on a condition of the user and distributing information there between with one or more secure channels. It is to be appreciated that system 400 can be an embodiment of the system 300 illustrated in FIG. 3. The system 400 can include a link component 202 that is configured to facilitate creating a relationship between a user and a treatment provider based at least upon a condition of the user (as discussed above). The link component 202 can facilitate data communication between the user and the treatment provider in order to establish a relationship and/or to create one or more secure channels 130 for data communication (as discussed above).

The system 400 can further include a data exchange component 204 that is configured to facilitate data communication between a user and a treatment provider that have a relationship established based on at least one of a condition of the user, a skill set of the treatment provider, an acceptance to distribute advice from the treatment provider, among others (as discussed above). The data exchange component 204 can be a stand-alone component (as illustrated), incorporated into the treatment manager component 120, incorporated into the patient manager component 110, or a combination thereof. The data exchange component 204 can facilitate data communications between the users 112 and the treatment providers 122, wherein the data can be, but is not limited to, medical advice, health advice, a subset of a set of parameters defined for a condition of a user, data representative of a parameter from a device, data used to establish a relationship between a user and a treatment provider, and the like. In an embodiment, the data exchange component 204 can use one or more secure channels 130 to communicate data. In another embodiment, the data exchange component 204 is the secure channel to communicate data. In still another embodiment, there can be one or more data exchange components 204 to facilitate data communications within the system 500.

The patient manager component 110 can further include a user registration component 230 that facilitates creating an account on a network for a user (as discussed above). The patient manager component 110 can further include a query component 240 that can facilitate identifying a treatment provider for the user and a specific condition. In another embodiment, the query component 240 can facilitate receiving a search term from a user and generating a query result based on the search term. For instance, a user can utilize the query component 240 to identify a physician for a condition that is covered by a health care plan of a health care insurance company.

The treatment manager component 120 can further include a provider registration component 250 that facilitates creating an account on the network for a treatment provider (as discussed above). The provider registration component 250 can communicate (e.g., receive and/or transmit) data with the patient manager component 110 and/or a user, wherein the communication facilitates establishing a relationship with one or more treatment providers. For instance, the communication can include user data (e.g., name, address, date of birth, and the like), health information (e.g., medical history, condition, treatments, prescriptions, etc.), payment information, health insurance information, among others. The provider registration component 250 can facilitate authorizing a treatment provider to link or establish a relationship with a user as well as validate or verify a condition to which the treatment provider can handle, treat, or advise. The treatment manager component 120 can further include a query component 260 that facilitates generating a search result based on a search term(s). For instance, a treatment provider can utilize the query component 260 to provide a search term and generate a result based on the search term. For instance, a treatment provider can identify a user with a particular condition in a particular geographic location.

It is to be appreciated that the one or more networks can be used with any suitable number of users 112 such as user₁ to user_{N}, wherein N is a positive integer. It is to be appreciated that the one or more networks can be used with any suitable number of providers (e.g., also referred to as treatment providers) such as provider₁ to provider_{M}, where M is a positive integer. It is to be appreciated that there can be any suitable number of secure channels 130 in the network such as secure channel₁ to secure channel_{T}, where T is a positive integer.

It is to be appreciated that any component from system 400 can be a stand-alone component, a sub-component, an integrated component with another component, a system described in another Figure (e.g., system 100, system 200, system 300, system 500, system 600, system 700, system 1700, and the like), and/or a combination thereof. Thus, functionality described in system 400 can be performed by any number of the components discussed.

FIG. 5 illustrates a system 500 that illustrates the establishment of a respective secure channel for each condition of a user in which the secure channel allows a secure exchange of data between the treatment provider in the relationship for such condition. It is to be appreciated that system 500 can be an embodiment of the system 300 illustrated in FIG. 3. The system 500 illustrates two secure channels for a user 114. A first secure channel 132 can be established between the user 114 and a first treatment provider (e.g., also referred to as provider) 124 based on a first condition. A second secure channel 134 can be established between the user 114 and a second treatment provider (e.g., also referred to as provider) 126 based on a second condition. It is to be appreciated that the information exchanged between the user 114 and the first treatment provider 124 is exclusively related to the first condition and the information exchanged between the user 114 and the second treatment provider 126 is exclusively related to the second condition. However, it is to be appreciated that if the first condition has been assigned a first subset of parameters by the first provider and the second condition has been assigned a second subset of parameters by the second provider, of which there are common parameters in the first subset and the second subset, the data collected for the common parameters can be communicated via a secure channel that is shared with the first treatment provider and the second provider. For instance, there can be an embodiment, in which the collected data representative of the subset of parameters is communicated over a secure channel and then distributed to the respective treatment provider. Thus, it is to be appreciated that the secure transmission of the data can be packaged and communicated in a manner selected by sound engineering judgment and/or one skilled in the art and such matter selected is not to be limiting on the subject innovation.

For example, the first secure channel 132 allows communication of data representative of a parameter or a parameter₁ to the first provider 124 from the user 114. The first secure channel 132 further allows communication of treatment₁ to the user 114. For example, the second secure channel 134 allows communication of data representative of a parameter or a parameter₂ to the second provider 126 from the user 114. The second secure channel 134 further allows communication of treatment₂ to the user 114.

As discussed above, the user 114 can select one or more devices 320 to collect or track one or more parameters 302, wherein such one or more parameters or data representative thereof are communicated through a secure channel on the network with the data exchange component 204 (e.g., data exchange component 204 facilitates creating one or more secure channels for data communication between the user 114 and a treatment provider). It is to be appreciated that the data exchange component 204 can be used to communicate parameter data (e.g., parameters 302) to the first secure channel 132 (as depicted), the second secure channel 134, an additional secure channel (not shown), or a combination thereof. In another embodiment, at least one of the patient manager component 110 or the treatment manager component 120 can be used as a secure channel to communicate data between a user and a treatment provider that has established a relationship.

It is to be appreciated that any component from system 500 can be a stand-alone component, a sub-component, an integrated component with another component, a system described in another Figure (e.g., system 100, system 200, system 300, system 400, system 600, system 700, system 1700, and the like), and/or a combination thereof. Thus, functionality described in system 500 can be performed by any number of the components discussed.

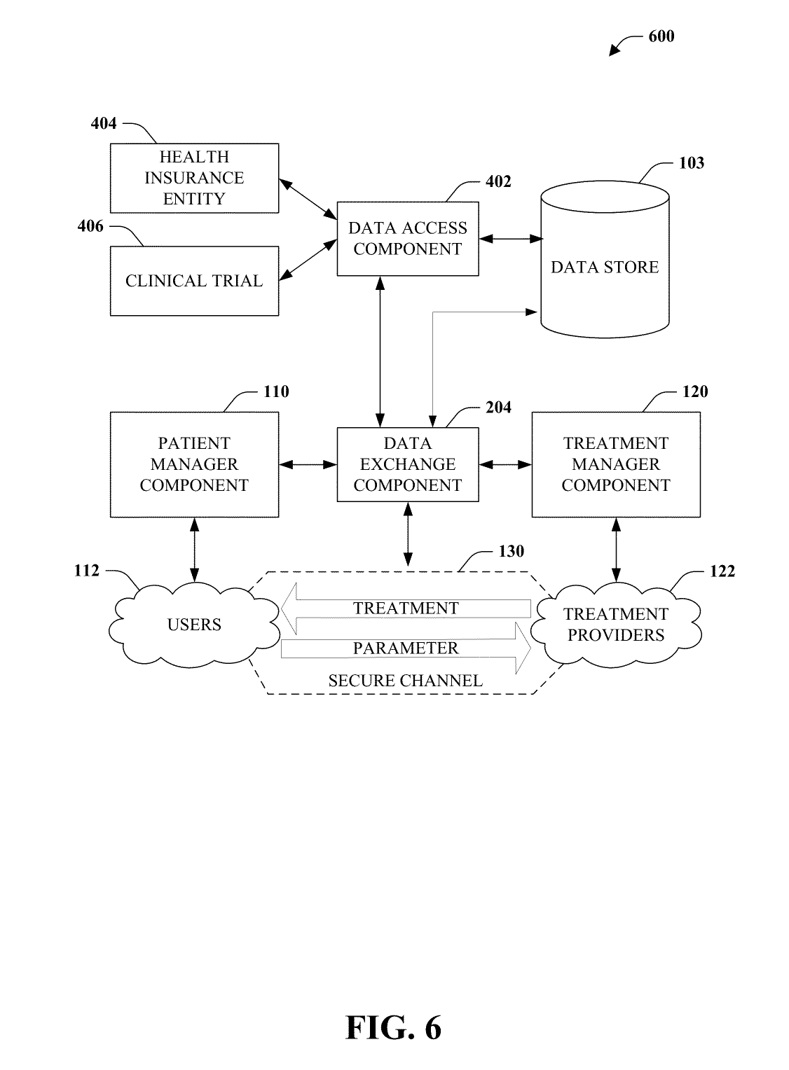

FIG. 6 illustrates a system 600 that facilitates leveraging data of one or more secure channels. It is to be appreciated that system 600 can be an embodiment of the system 300 illustrated in FIG. 3. The system 600 can include a data access component 402 that is configured to implement and/or manage data communication between a health insurance entity 404 and one or more networks; (e.g., in particular data used with one or more relationships established between the user and the treatment provider). The data access component 402 is further configured to implement and/or manage data communication between an entity employing a clinical trial 406 and the one or more networks (e.g., in particular data used with one or more relationships established between the user and the treatment provider).

The health insurance entity 404 can be any suitable entity (e.g., business, person, group, organization, etc.) that provides health insurance (e.g., group, individual, family, etc.). The health insurance entity 404 can communicate with at least one of a user or a treatment provider in order to provide reimbursement or payment for use of a kit (e.g., a subset of parameters for a condition) to facilitate treatment of a condition with advice from a treatment provider based on the kit. For instance, the health insurance entity 404 can provide a reimbursement or payment such as, but not limited to, discount, promotion, rate decrease, special rate, refund, money, and the like. The reimbursement or payment can be determined based on the kit and the advice based on the kit being preventative medicine or preventative health advice which lowers costs for at least one of health insurance, treatment, diagnosis, checkups, appointments, the treatment provider, among others. In another example, the health insurance entity 404 can evaluate data associated with the one or more networks (and in particular data used with one or more relationships established between the user and the treatment provider) for research on costs, preventative medicine, and the like. In such example, the data access component 402 can remove personal and/or sensitive information from data. Moreover, the health insurance entity 404 can provide reimbursement or payment to allow access to data communicated during an established relationship between a user and a treatment provider. For instance, the health insurance entity 404 may want access to data for a condition to evaluate a prescribed or assigned kit, wherein the user and/or the treatment provider in an established relationship to mitigate the condition can be reimbursed or paid.

In another example, an insurance company can pay for an existing medical service (e.g., measure peak expiratory flow for an asthma patient) provided through the subject innovation. In particular, the asthma patient can regularly tracks Peak Expiratory Flow (PEF) through office visits with a doctor and can then be “prescribed” a kit that includes a device to track PEF remotely and communicate the tracked PEF to the doctor through the network and/or the subject innovation. Thus, the insurance company could pay (e.g., reimburse, pay, discount, etc.) for the “kit” and the PEF reading by the doctor.

The clinical trial 406 can further access a portion of data from the network in which simulations can be evaluated without affecting physical users. For instance, a clinical trial can be employed based on data alone rather than exposing individuals into the trial itself. In an embodiment, this can be a retroactive study. Moreover, the study can be done by allowing users to opt-in or participate via at least one of the patient manager component 110 or the treatment manager component 120.

The data store 103 can store data and/or media from the system 600 such as, but not limited to, conditions, parameters, sets of parameters for a condition, subsets of parameters assigned for a user, which data representative of a parameter a device collects, user data (e.g., age, height, weight, etc.), treatment provider data, devices, environment data (e.g., geographic data, weather, food eating habits, food available, etc.), data collection parameters (e.g., date, time, rate, frequency, etc.), and the like. For instance, any data used with the subject innovation can utilize privacy techniques so as to be in compliance of government regulations such as, but not limited to, Health Insurance Portability and Accountability Act (HIPAA), and the like. It is to be appreciated that the data store 103 can be, for example, either volatile memory or nonvolatile memory, or can include both volatile and nonvolatile memory. The data store 103 of the subject systems and methods is intended to comprise, without being limited to, these and other suitable types of memory. In addition, it is to be appreciated that the data store 103 can be a server, a database, a hard drive, a flash drive, an external hard drive, a portable hard drive, a cloud-based storage, a solid-state drive, a distributed storage system, and the like. The data store 103 can further be a local data store, a remote data store, a cloud-based data store, or a combination thereof.

It is to be appreciated that any component from system 600 can be a stand-alone component, a sub-component, an integrated component with another component, a system described in another Figure (e.g., system 100, system 200, system 300, system 400, system 500, system 700, system 1700, and the like), and/or a combination thereof. Thus, functionality described in system 600 can be performed by any number of the components discussed.

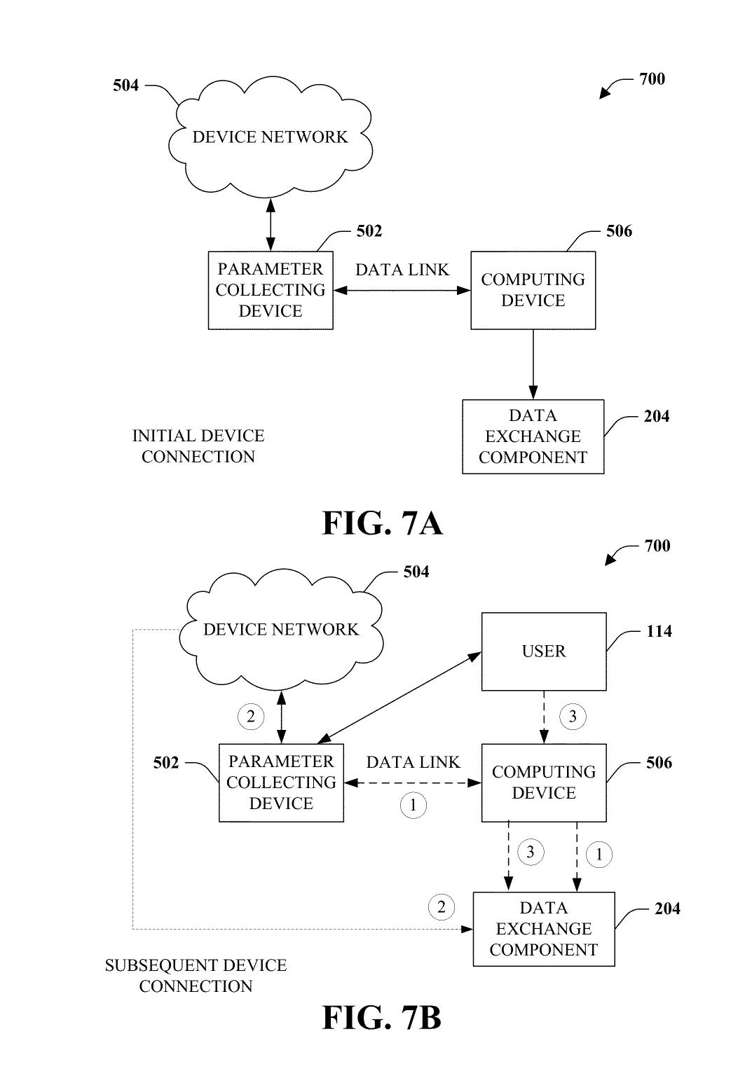

FIGS. 7A and 7B illustrate a system 700 that facilitates connecting a device to transmit data representative of a parameter, wherein the connecting is an initial or first device connection. FIG. 7B illustrates a system 700 that facilitates connecting a device to transmit data representative of a parameter subsequent a connection to a network specific to the device. It is to be appreciated that FIGS. 7A and 7B illustrate data collected from a device being communicated by a network specific to the device. For instance, a wearable device can collect data from a user and such data can be uploaded or communicated to a device network specific to the device. In such example, the subject innovation can receive data from the device, from the device network, or the user can select to communicate the data manually.

Turning to FIG. 7A, a system 700 illustrates a device network 504 that can be specific to a parameter collecting device 502 (e.g., also referred to as a device) in which the device network 504 receives and/or hosts a portion of data collected by the parameter collecting device 502. For instance, a wearable device can collect vital signs of a user and such data can be hosted or stored on a respective wearable device network. The data collected by the wearable device can be communicated to the device network 504 over one or more networks and/or one or more devices. For instance, the wearable device can be connected to a computer or smartphone and the computer or smartphone can communicate the collected data to the device network 504. The parameter collecting device 502 can have a data link to a computing device 506, wherein the data link can be a wired or wireless connection. For instance, the data link can be a USB cord, a Bluetooth connection, a wireless fidelity (WI-FI) connection, among others. The computing device 506 can be, for instance, a tablet, a desktop computer, a laptop, a smartphone, among others. The computing device 506 can further communicate with the data exchange component 204 that facilitates data communication (here, the parameter data from the device 502 to the network) such that the data collected can be communicated to the treatment provider. FIG. 7A illustrates the ability to connect the device 502 to the device network 504 as well as a data exchange component 204 to allow the subject innovation to utilize the data collected from a device 502. The connection of the device 502 to the device network 504 and the device 502 to the data exchange component 204 can be simultaneous, independent of one another, or a combination thereof.

Turning to FIG. 7B, the system 700 illustrates a subsequent connection of the parameter collecting device 502 such that data collected is communicated to the device network 504 or the data exchange component 204 in various manners. In particular, the data collected can be communicated to the device network 504 and/or the data exchange component 204 for communication with one or more treatment providers. The data communications from the device 502 to the device network 504 and the device 502 to the data exchange component 204 can be simultaneous, independent of one another, or a combination thereof.

In reference numeral 1, a data communication is illustrated for the device 502. In such example, a data link is utilized to connect the parameter collecting device 502 to the computing device 506 to allow data collected by the device 502 to be transmitted to the device network 504 and/or to a treatment provider via the data exchange component 204. This data communication can be employed upon a physical connection of the data link or an established wireless connection for the data link. In an embodiment where there is no device network 504 for the device 502, the established data link can initiate data communication to the treatment provider via the data exchange component 204.

In reference numeral 2, a data communication is illustrated for the device 502. In such example, the parameter collecting device 502 can communicate collected data to the device network 504 and additionally communicate the collected data (or a subset of such collected data) to the data exchange component 204 (and ultimately to the treatment provider). In an example, the user can provide credentials to the data exchange component 204, wherein the credentials afford access to the device network 504. In such example, data can be pulled from the device network 504 and the synchronizing of collected data can be handled by the device 502 and/or device network 504. Following such example, the device 502 can push data collected to the device network 504 and the data exchange component 204 can pull data from the device network 504 based on authorization from the user (e.g., owner of the device 502 which has authorized access to the device network 504). It is to be appreciated that upon pushing data from the device 502 to the device network 504, the user can provide authorization to have data pushed simultaneously to the treatment provider and/or data exchange component 204.

In reference numeral 3, a data communication is illustrated for the device 502. In such example, the user 114 can view and manually enter data representative of the parameter(s) based on a reading of the parameter collecting device 502 or other devices, wherein the user 114 uses the computing device 506 to communicate manually entered data to the data exchange component 204 and to the treatment provider. It is to be appreciated that manually entered data can be utilized for any device 502 regardless of having the ability to push or pull data. In an example, a device may have the technological capabilities to communicate electronic data. The manual entry can be used to allow legacy devices to be used with the subject innovation.

The communication of data representative of at least one parameter of the subset of parameters from the device can be selected by sound engineering judgment and/or one skilled in the art and is not intended to be limiting on the subject innovation. The data collected by a device can be communicated by one or more data links, one or more networks, and/or one or more devices. For instance, a wearable device can communicate via Bluetooth® to a smartphone and such smartphone can communicate via a cellular network to a website that hosts data for the wearable device. In such example, the data collected can be received from at least one of the smartphone, the Bluetooth® device, the cellular network, a pull of data from the website, among others. In general, the techniques used to collect data from one or more devices that are capable of collecting one or more parameters for a kit can be selected with sound engineering judgment and/or one skilled in the art. Such techniques to collect data for transmission to a treatment provider (directly or indirectly) are not to be limiting on the subject innovation.

It is to be appreciated that any component from system 700 can be a stand-alone component, a sub-component, an integrated component with another component, a system described in another Figure (e.g., system 100, system 200, system 300, system 400, system 500, system 600, system 1700, and the like), and/or a combination thereof. Thus, functionality described in system 700 can be performed by any number of the components discussed.

The aforementioned systems, components, (e.g., server component 102, patient manager component 110, treatment manager component 120, link component 202, data exchange component 204, data access component 402, among others), and the like have been described with respect to interaction between several components and/or elements. It should be appreciated that such devices and elements can include those elements or sub-elements specified therein, some of the specified elements or sub-elements, and/or additional elements. Further yet, one or more elements and/or sub-elements may be combined into a single component to provide aggregate functionality. The elements may also interact with one or more other elements not specifically described herein.

In view of the exemplary devices and elements described supra, methodologies that may be implemented in accordance with the disclosed subject matter will be better appreciated with reference to the flow charts of FIGS. 8-16. While for purposes of simplicity of explanation, the methodologies are shown and described as a series of blocks, it is to be understood and appreciated that the claimed subject matter is not limited by the order of the blocks, as some blocks may occur in different orders and/or concurrently with other blocks from what is depicted and described herein. Moreover, not all illustrated blocks may be required to implement the methods described hereinafter.

FIG. 8 illustrates a method 800 that facilitates establishing a secure channel on a network for a treatment provider to transmit medical advice and/or health advice to a user, wherein the secure channel is used to deliver assigned subset of parameters that the treatment provider uses to better manage a condition of the user. At reference number 810, a username and a password can be authenticated for a treatment provider to access a network. In an embodiment, an authentication can be utilized to verify the treatment provider on the network. By way of example, the username can be at least one of a letter, a number, a sound (e.g., voice authentication, word used as authentication, etc.), a motion (e.g., hand gesture, etc.), a pattern or a symbol (e.g., drawing a pattern on a touchpad, writing a symbol on an input device, etc.), or a combination thereof. Additionally, the password can be at least one of a letter, a number, a sound (e.g., voice authentication, word used as authentication, etc.), a motion (e.g., hand gesture, etc.), a pattern or a symbol (e.g., drawing a pattern on a touchpad, writing a symbol on an input device, etc.), or a combination thereof. In another embodiment, a human interactive proof (HIP) can be utilized to thwart machine-based connection to the network. For instance, the HIP can be a displayed portion of text, portion of numbers, or a combination thereof to which a user must enter for verification. In another instance, the HIP can be an audible sound or word that is output for a user to enter for verification. It is to be appreciated that any suitable HIP can be used with the subject innovation and such examples are not to be limiting.

At reference number 820, a request from a user can be received to electronically interact with the treatment provider over the network, wherein the request is based on a condition of the user. In other words, the treatment provider is designated as able to communicate medical advice and/or health advice on the condition of the user. It is to be appreciated that the treatment provider can be verified by the network, the treatment manager component 120, a third-party, an entity, or a combination thereof. In another embodiment, the request can be received from the treatment provider to electronically interact with the user over the network.

At reference numeral 830, an acceptance of the request can be communicated from the treatment provider to the user. For instance, the acceptance can be an electronic communication such as an email, a text, a voicemail, a message on the network, and the like. The acceptance can further be an electronic signal that the network utilizes to confirm a relationship is established between the user and a particular treatment provider. In another example, the acceptance of the request can be communicated from the user to the treatment provider.

At reference numeral 840, a request to the user can be communicated for one or more parameters related to the condition. In an embodiment, one or more parameters can be factors of the condition that the treatment provider would like to monitor to treat the condition. Based upon at least the condition of the user to which a treatment provider has established a relationship, the treatment provider can assign a subset of parameters from a set of parameters defined for the condition. The assignment of the subset of parameters can be tailored to the user.

The parameters can be related to at least one of an activity of the user (e.g., exercise, steps walked, movement, etc.), a condition of the user (e.g., asthma, COPD, etc.), a food intake of the user (e.g., diet, food consumed, etc.), a medicinal intake of the user (e.g., prescription use, medicine application, medicine intake, adhering to treatment, etc.), a habit of the user (e.g., sleep, exercise, meals, etc.), a geographic location of the user, an environmental condition of the user (e.g., temperature, pollen count, time of day, humidity, etc.), a biometric reading related to the user (e.g., heart rate, blood pressure, glucose level, breathing, body temperature, perspiration, etc.), a parameter that the treatment provider evaluates to treat the condition, among others.

At reference numeral 850, the one or more parameters (specifically data representative of the subset of parameters) can be received from the user via the network. For instance, the user can utilize one or more devices (or data techniques) to collect data representative of the one or more parameters, wherein such data is communicated and received by the network. As discussed above, the user can identify one or more devices or data techniques to collect data representative of the subset of parameters. Such collected data representative of the subset of parameters can further be communicated to the treatment provider to which the user has established a relationship

At reference numeral 860, a portion of medical advice and/or health advice related to the user can be transmitted via the network to treat the condition of the user based on the one or more parameters received from the user. As discussed above, with the data representative of the subset of parameters, the treatment provider can provide at least one of the health advice, medical advice, and/or adjustment of the subset of parameters to mitigate the condition. For example, an adjustment can be a re-selection or re-assignment of parameters from the set of parameters for a condition. In another embodiment, the medical advice and/or health advice can be transmitted by a communication. In an embodiment, the communication can be, but is not limited to, an email, a text, a telecommunication, a message, a short-message-service, an electronic message, an audio file, a real-time video communication, a communication via the Internet, and the like. In other words, the communication of health advice and/or medical advice to the user from the treatment provider can be communicated with at least one of the network, a portion of the network, or without the network. In general, one or more networks can be used for the various data communications used with the subject innovation. In another embodiment, the medical advice and/or health advice can be transmitted by a communication outside the network used for the collection of data representative of the subset of parameters. Yet, it is to be appreciated that the communication can be provided within the network used for the collection of data representative of the subset of parameters.

FIG. 9 illustrates a method 900 that facilitates establishing a secure channel on a network for a user to receive medical advice and/or health advice from a treatment provider. At reference numeral 910, a username and a password for a user can be authenticated to access a network. At reference numeral 920, a request can be communicated from a user to electronically interact with a treatment provider over the network, wherein the request is based on a condition of the user. In another example, the request can be communicated from the treatment provider to the user. At reference numeral 930, an acceptance of the request can be received from the treatment provider. In another embodiment, the acceptance can be received from the user.

At reference numeral 940, a request can be received from the treatment provider for one or more parameters related to the condition, wherein this request of one or ore parameters can be an assignment or prescription of a kit (e.g., a subset of parameters from a set of parameters defined for the condition). Based upon at least the condition of the user to which a treatment provider has established a relationship, the treatment provider can assign a subset of parameters from a set of parameters defined for the condition. The assignment of the subset of parameters can be tailored to the user.

At reference numeral 950, one or more devices can be selected that collect data for at least one of the one or more parameters (e.g., the kit or subset of parameters). Such subset of parameters can be communicated to the user, wherein the user can identify one or more devices or data techniques to collect data representative of the subset of parameters.

At reference numeral 960, data collected can be transmitted to the treatment provider over the network. Such collected data representative of the subset of parameters can further be communicated to the treatment provider to which the user has established a relationship. At reference numeral 970, a portion of medical advice and/or health advice from the treatment provider can be received via the network to treat the condition based on data collected. With the data representative of the subset of parameters, the treatment provider can provide at least one of the health advice, medical advice, and/or adjustment of the subset of parameters to mitigate the condition. For example, an adjustment can be a re-selection or re-assignment of parameters from the set of parameters for a condition.

It is to be appreciated that a manner in which the network collects the one or more parameters is HIPAA compliant. For instance, privacy techniques for data can be utilized with the subject innovation so as to be in compliance of government regulations such as, but not limited to, Health Insurance Portability and Accountability Act (HIPAA), and the like.

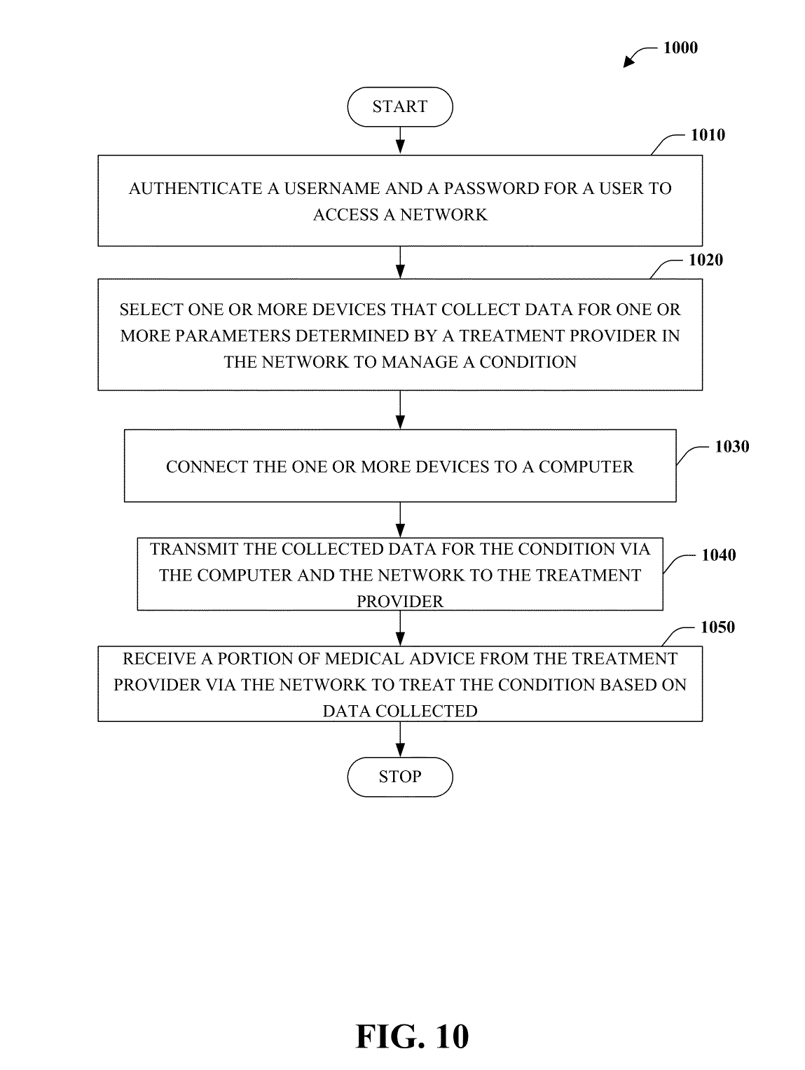

FIG. 10 illustrates a method 1000 that facilitates transmitting data representative of a parameter in order to receive medical advice and/or health advice for a condition of a user. At reference numeral 1010, a username and a password for a user can be authenticated to access a network, wherein the network allows establishment of a relationship between a user and at least one treatment provider based on a condition of the user.

At reference numeral 1020, one or more devices can be selected that collect data for one or more parameters determined by a treatment provider in the network to manage a condition. The one or more devices selected can be based upon an assignment of a subset of parameters from a set of parameters defined for a condition, wherein the one or more devices can collect data representative of the subset of parameters.

At reference numeral 1030, the one or more devices are connected to a computer. In this example, the one or more devices can directly communicate collected data to a treatment provider. In another example, the one or more devices can communicate collected data to a network specific to the particular device. In such example with data communication to the device specific network, the data collected can be indirectly communicated to the treatment provider. For instance, data access to the device specific network can be provided by the user to allow communication of the collected data to both the device specific network and the treatment provider.

At reference numeral 1040, the collected data for the subset of parameters assigned to mitigate the condition of the user can be transmitted via the computer and the network to the treatment provider.

At reference numeral 1050, medical advice and/or health advice can be received from the treatment provider based upon the collected data for the subset of parameters. The medical advice and/or health advice can be delivered to the user from the treatment provider via the network to mitigate the condition based on the collected data. In another embodiment, the medical advice and/or health advice can be transmitted by a communication outside the network used for the collection of data representative of the subset of parameters. Yet, it is to be appreciated that the communication can be provided within the network used for the collection of data representative of the subset of parameters. In an embodiment, the communication outside the network can be, but is not limited to, an email, a text, a telecommunication, a message, a short-message-service, an electronic message, an audio file, a real-time video communication, a communication via the Internet, and the like. In other words, the communication of health advice and/or medical advice to the user from the treatment provider can be communicated with one or more networks.

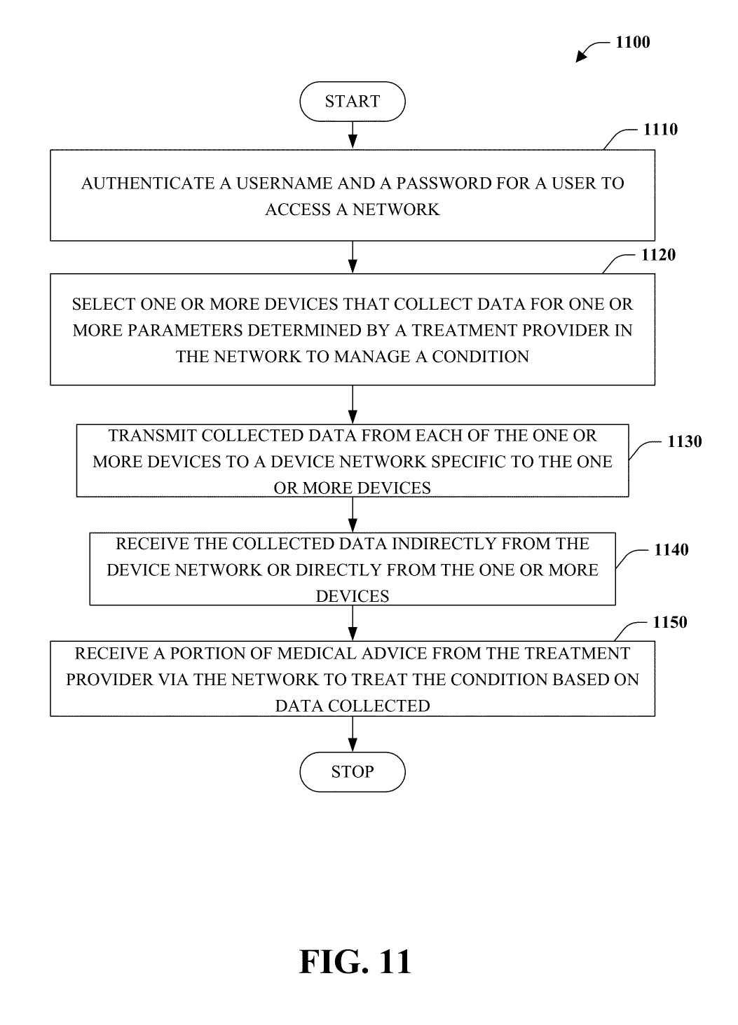

FIG. 11 illustrates a method 1100 that facilitates receiving data representative of a parameter from a device network specific to a device. At reference numeral 1110, a username and a password for a user can be authenticated to access a network.

At reference numeral 1120, one or more devices can be selected that collect data for one or more parameters determined by a treatment provider in the network to manage a condition. The one or more devices selected can be based upon an assignment of a subset of parameters from a set of parameters defined for a condition, wherein the one or more devices can collect data representative of the subset of parameters.

At reference numeral 1130, collected data can be transmitted from each of the one or more devices to a device network specific to the one or more devices. In this example, the one or more devices can communicate collected data to a network specific to the particular device. In such example with data communication to the device specific network, the data collected can be indirectly communicated to the treatment provider. For instance, data access to the device specific network can be provided by the user to allow communication of the collected data to both the device specific network and the treatment provider. In an example, the one or more devices can directly communicate collected data to a treatment provider.

At reference numeral 1140, the collected data representative of the subset of parameters can be received indirectly from the device network from the one or more devices upon transmission of data to the device network.

At reference numeral 1150, medical advice and/or health advice can be received from the treatment provider, wherein the advice is based upon the collected data for the subset of parameters. The medical advice and/or health advice can be delivered to the user from the treatment provider via the network to mitigate the condition of the user based on the data collected representative of the subset of parameters. In an embodiment, a portion of medical advice and/or health advice can be transmitted from the treatment provider to the user via the network and, in particular, a secure channel. In another embodiment, the medical advice and/or health advice can be transmitted by a communication outside the network used for the collection of data representative of the subset of parameters. Yet, it is to be appreciated that the communication can be provided within the network used for the collection of data representative of the subset of parameters. In an embodiment, the communication outside the network can be, but is not limited to, an email, a text, a telecommunication, a message, a short-message-service, an electronic message, an audio file, a real-time video communication, a communication via the Internet, and the like. In other words, the communication of health advice and/or medical advice to the user from the treatment provider can be communicated with one or more networks.

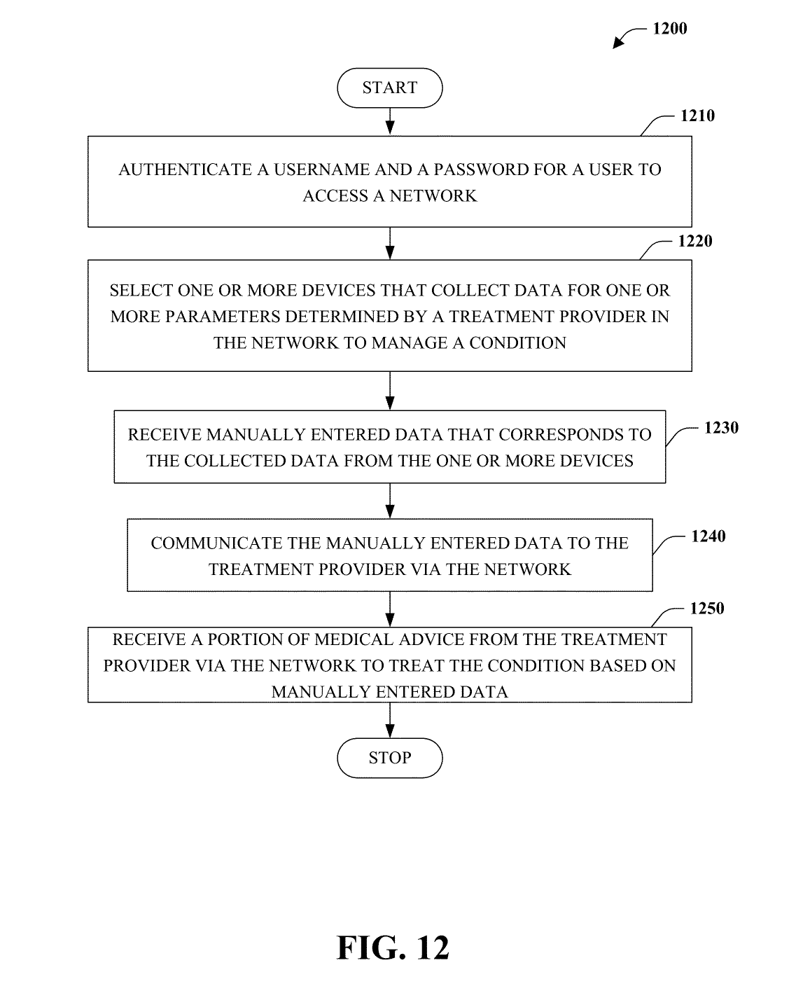

FIG. 12 illustrates a method 1200 that facilitates utilizing manually entered data representative of a parameter to which a treatment provider can provide medical advice and/or health advice. At reference numeral 1210, a username and a password for a user can be authenticated to access a network.

At reference numeral 1220, one or more devices can be selected that collect data for one or more parameters determined by a treatment provider in the network to manage a condition. The one or more devices selected can be based upon an assignment of a subset of parameters from a set of parameters defined for a condition, wherein the one or more devices can collect data representative of the subset of parameters.

At reference numeral 1230, manually entered data that corresponds to the collected data for the subset of parameters from the one or more devices can be received. For instance, the data can be manually entered by the user.

At reference numeral 1240, the manually entered data representative of the subset of parameters can be communicated to the treatment provider via the network.

At reference numeral 1250, medical advice and/or health advice from the treatment provider can be received, wherein the advice is based upon the collected data for the subset of parameters and used to mitigate the condition of the user. In an embodiment, a portion of medical advice and/or health advice can be transmitted from the treatment provider to the user via the network and, in particular, a secure channel.

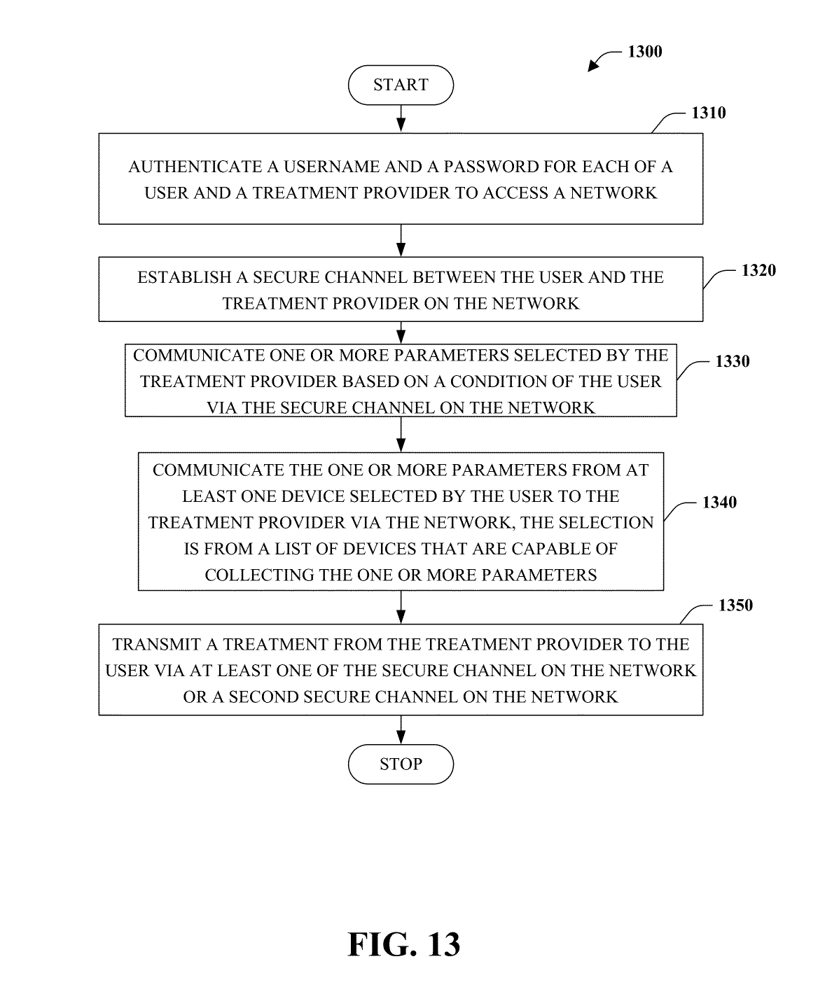

FIG. 13 illustrates a method 1300 that facilitates selecting one or more devices to collect data representative of one or more parameters (e.g., a kit or subset of parameters from a set of parameters defined for a condition). At reference numeral 1310, a username and a password for a user can be authenticated to access a network.

At reference numeral 1320, a secure channel can be established between the user and the treatment provider on the network.

At reference numeral 1330, one or more parameters (e.g., a kit or subset of parameters from a set of parameters defined for a condition) selected by the treatment provider can be communicated via the secure channel on the network, wherein the one or more parameters are selected based on a condition of the user.

At reference numeral 1340, data representative of the one or more parameters (e.g., a kit or subset of parameters from a set of parameters defined for a condition) can be communicated from at least one device or data technique selected by the user to the treatment provider, wherein the selection is from a list of devices or data techniques that are capable of collecting data representative of the one or more parameters (e.g., corresponding a device or data technique that collects data representative of the subset of parameters).

At reference numeral 1350, a health advice and/or medical advice from the treatment provider can be transmitted to the user via one or more secure channel on one or more networks.

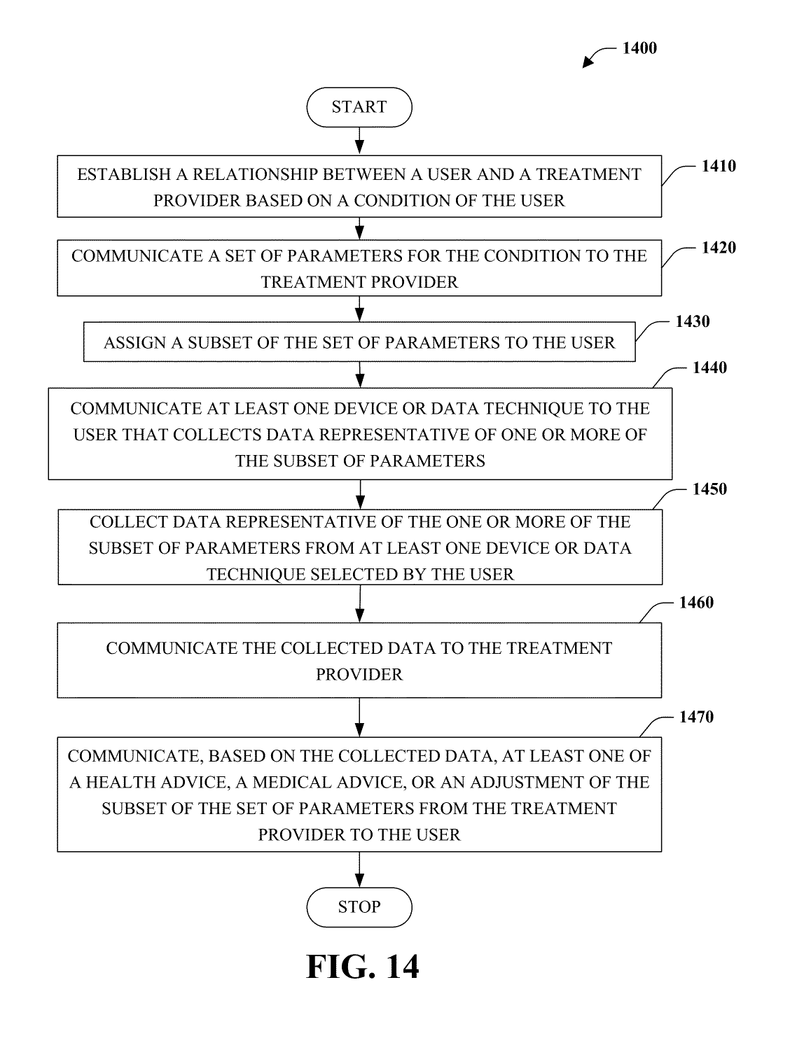

FIG. 14 illustrates a method 1400 that facilitates communicating a kit to a user from a treatment provider that has an established relationship with the user. At reference numeral 1410, a relationship between a user and a treatment provider can be established based upon a condition of the user. For instance, a medical doctor can treat a condition of a user and an electronic data communication relationship can be established over one or more networks with one or more computing devices.

At reference numeral 1420, a set of parameters for the condition can be communicated to the treatment provider. The set of parameters can be, for example, used to mitigate or better the condition of the user. At reference numeral 1430, a subset of the set of parameters can be assigned to the user. For instance, the treatment provider can assign a subset of parameters to a user in which the assignment is specific to the condition of the user and may include one or more criteria associated with the user. By way of example and not limitation, the information related to the particular user can be at least one of family history, medical history, previous health conditions, DNA, genetics, genetic makeup, genetic sequencing, health statistics, age, sex, an amount of exercise, a body fat percentage, a lifestyle type (e.g., athletic, obese, alcoholic, vegetarian, vegan, and the like), a diet, a food intake, geographic location, heart rate, blood pressure, cholesterol, a disease, a diagnosis of a health condition other than the condition to which the relationship is established, a characteristic that has shown to impact the condition to which the relationship is established, among others.

At reference numeral 1440, at least one device or data technique that collects data representative of one or more of the subset of parameters can be communicated to the user. At reference numeral 1450, data representative of the one or more of the subset of parameters can be collected from at least one device or data technique selected by the user.

At reference numeral 1460, the collected data can be communicated to the treatment provider. At reference numeral 1470, based on the collected data, at least one of health advice, medical advice, or an adjustment of the subset of the set of parameters can be communicated from the treatment provider. For example, an adjustment can be a re-selection or re-assignment of parameters from the set of parameters for a condition.

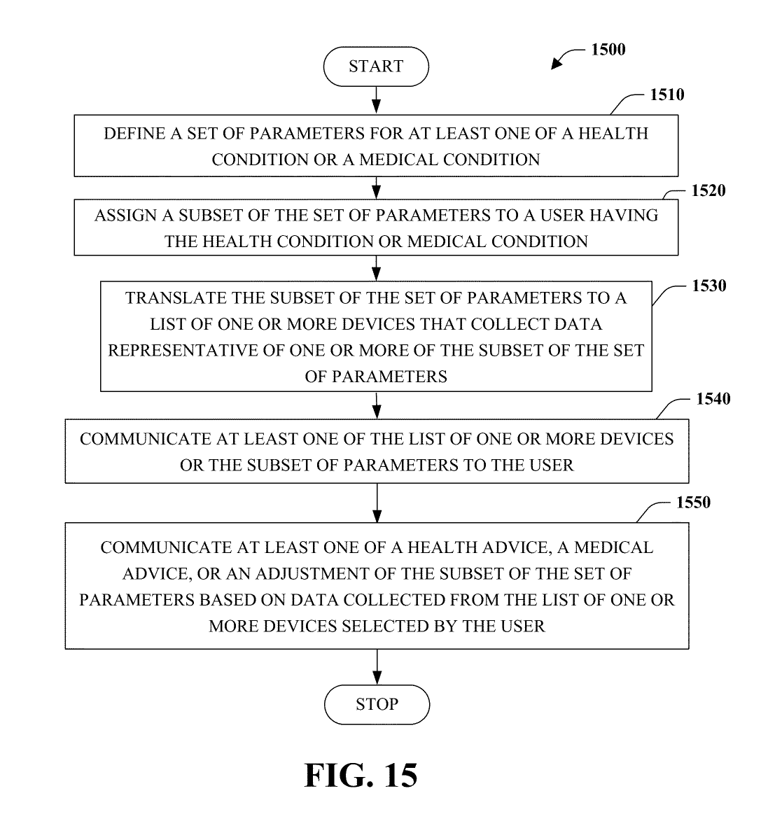

FIG. 15 illustrates a method 1500 that facilitates providing medical and/or health advice. At reference numeral 1510, a set of parameters for at least one of a health condition or a medical condition can be defined. At reference numeral 1520, a subset of the set of parameters can be assigned to a user having the health condition or the medical condition. In an embodiment, the assignment can be from a treatment provider that has an established relationship with the user.

At reference numeral 1530, the subset of the set of parameters can be translated to a list of one or more devices that collect data representative of one or more of the subset of the set of parameters. At reference numeral 1540, at least one of the list of one or more devices or the subset of parameters can be communicated to the user.

At reference numeral 1550, at least one of a health advice, a medical advice, or an adjustment of the subset of the set of parameters can be communicated based on the data collected from the list of one or more devices selected by the user. For example, an adjustment can be a re-selection or re-assignment of parameters from the set of parameters for a condition.

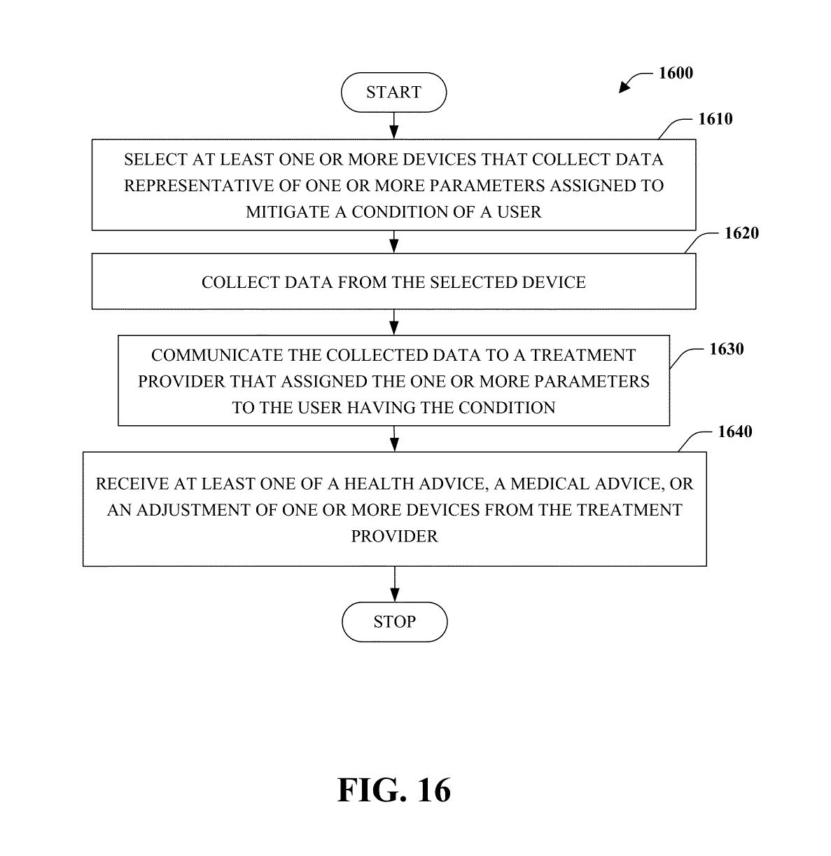

FIG. 16 illustrates a method 1600 that facilitates providing medical and/or health advice. At reference numeral 1610, at least one or more devices that collect data representative of one or more parameters assigned to mitigate a condition of a user can be selected. At reference numeral 1620, data from the selected device can be collected. At reference numeral 1630, the collected data can be communicated to a treatment provider that assigned the one or more parameters to the user having the condition. At reference numeral 1640, at least one of a health advice, a medical advice, or an adjustment of the one or more devices can be received from the treatment provider. For example, an adjustment can be a re-selection or re-assignment of parameters from the set of parameters for a condition.

In an embodiment, the condition is overweight, the portion of medical advice and/or health advice is a weight loss plan, and the one or more parameters is at least one of a calorie intake, a fat content intake, a measurement of activity, or a biometric parameter reading of the user. In an embodiment, the condition is strength training, the portion of medical advice and/or health advice is a workout plan, and the one or more parameters is at least one of a calorie intake, a fat content intake, a protein intake, a carbohydrate intake, a measurement of activity, a vital sign, a weight of the user, a progress of an exercise routine, or a biological parameter of the user.

In an embodiment, the condition is at least one of asthma, Chronic Obstructive Pulmonary Disease (COPD), an allergy, smoking cessation, a condition related to a user's respiratory system, a condition related to a user's cardiovascular system, hypertension, arrhythmias, ischemic cardiac disease, diabetes, a condition related to a user's renal system, a psychological disorders, or a condition that requires a scheduled activity. In an embodiment, the condition is a medical disease and the one or more parameters is at least one of an intake of medicine, an application of medicine, a physical therapy, a biological parameter, or a vital sign reading.

In an embodiment, the step of selecting one or more devices that collect data for at least one of the one or more parameters further comprises: connecting the one or more devices to a computer; and transmitting the collected data for the condition from the computer and the network to the treatment provider. In an embodiment, the step of selecting one or more devices that collect data for at least one of the one or more parameters further comprises: transmitting collected data from each of the one or more devices to a device network specific to the one or more devices; and receiving the collected data indirectly from the device network or directly from the one or more devices.

In an embodiment, the method can include receiving manually entered data that is representative of one or more parameters; and communicating the manually entered data to the treatment provider based on the condition-specific relationship.

In an embodiment, the treatment provider is at least one of a board certified physician. In an embodiment, the treatment provider is at least one of a physical therapist, a personal trainer, a dietitian, a fitness professional, a nutritionist, a weight trainer, among others.

In an embodiment, the device is at least one of a smartphone, a tablet, a pedometer, a device that monitors a biological parameter, a weight scale with a network connection, a wireless device, an RFID device, an NFC device, a Bluetooth device, a heart monitor, a wearable device with a network connection, a device that collects a biological parameter that communicates the biological parameter via the Internet, or a device with an input for manual data entry.

As used herein, the terms “component” and “system,” as well as forms thereof are intended to refer to a computer-related entity, either hardware, a combination of hardware and software, software, or software in execution. For example, a component may be, but is not limited to being, a process running on a processor, a processor, an object, an instance, an executable, a thread of execution, a program, and/or a computer. By way of illustration, both an application running on a computer and the computer can be a component. One or more components may reside within a process and/or thread of execution and a component may be localized on one computer and/or distributed between two or more computers.

The word “exemplary” or various forms thereof are used herein to mean serving as an example, instance, or illustration. Any aspect or design described herein as “exemplary” is not necessarily to be construed as preferred or advantageous over other aspects or designs. Furthermore, examples are provided solely for purposes of clarity and understanding and are not meant to limit or restrict the claimed subject matter or relevant portions of this disclosure in any manner. It is to be appreciated a myriad of additional or alternate examples of varying scope could have been presented, but have been omitted for purposes of brevity.

Furthermore, to the extent that the terms “includes,” “contains,” “has,” “having” or variations in form thereof are used in either the detailed description or the claims, such terms are intended to be inclusive in a manner similar to the term “comprising” as “comprising” is interpreted when employed as a transitional word in a claim.

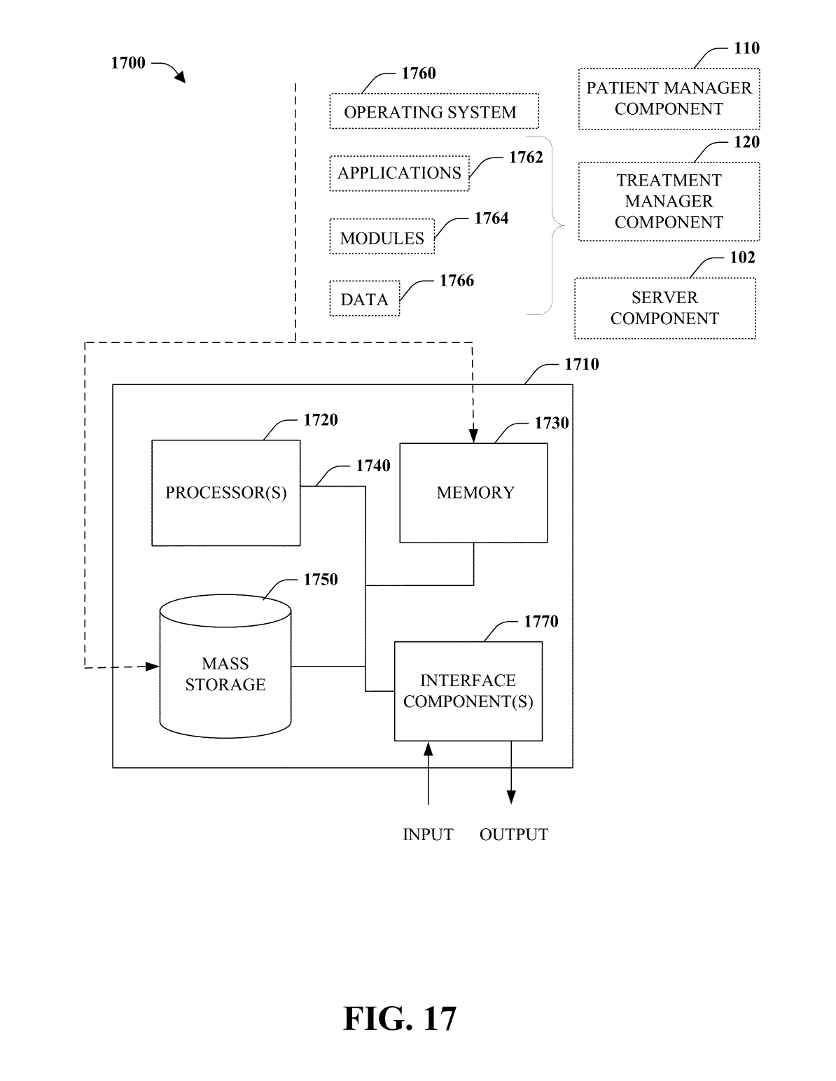

In order to provide a context for the claimed subject matter, FIG. 17 as well as the following discussion are intended to provide a brief, general description of a suitable environment in which various aspects of the subject matter can be implemented. The suitable environment, however, is only an example and is not intended to suggest any limitation as to scope of use or functionality.

While the above disclosed system and methods can be described in the general context of computer-executable instructions of a program that runs on one or more computers, those skilled in the art will recognize that aspects can also be implemented in combination with other program modules or the like. Generally, program modules include routines, programs, components, data structures, among other things that perform particular tasks and/or implement particular abstract data types. Moreover, those skilled in the art will appreciate that the above systems and methods can be practiced with various computer system configurations, including single-processor, multi-processor or multi-core processor computer systems, mini-computing devices, mainframe computers, as well as personal computers, hand-held computing devices (e.g., personal digital assistant (PDA), portable gaming device, smartphone, tablet, Wi-Fi device, laptop, phone, among others), microprocessor-based or programmable consumer or industrial electronics, and the like. Aspects can also be practiced in distributed computing environments where tasks are performed by remote processing devices that are linked through a communications network. However, some, if not all aspects of the claimed subject matter can be practiced on stand-alone computers. In a distributed computing environment, program modules may be located in one or both of local and remote memory storage devices.

With reference to FIG. 17, illustrated is an example general-purpose computer 1710 or computing device (e.g., desktop, laptop, server, hand-held, programmable consumer or industrial electronics, set-top box, game system . . . ). The computer 1710 includes one or more processor(s) 1720, memory 1730, system bus 1740, mass storage 1750, and one or more interface components 1770. The system bus 1740 communicatively couples at least the above system components. However, it is to be appreciated that in its simplest form the computer 1710 can include one or more processors 1720 coupled to memory 1730 that execute various computer executable actions, instructions, and or components stored in memory 1730.

The processor(s) 1720 can be implemented with a general purpose processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A general-purpose processor may be a microprocessor, but in the alternative, the processor may be any processor, controller, microcontroller, or state machine. The processor(s) 1720 may also be implemented as a combination of computing devices, for example a combination of a DSP and a microprocessor, a plurality of microprocessors, multi-core processors, one or more microprocessors in conjunction with a DSP core, or any other such configuration.

The computer 1710 can include or otherwise interact with a variety of computer-readable media to facilitate control of the computer 1710 to implement one or more aspects of the claimed subject matter. The computer-readable media can be any available media that can be accessed by the computer 1710 and includes volatile and nonvolatile media, and removable and non-removable media. By way of example, and not limitation, computer-readable media may comprise computer storage media and communication media.

Computer storage media includes volatile and nonvolatile, removable and non-removable media implemented in any method or technology for storage of information such as computer-readable instructions, data structures, program modules, or other data. Computer storage media includes, but is not limited to memory devices (e.g., random access memory (RAM), read-only memory (ROM), electrically erasable programmable read-only memory (EEPROM) . . . ), magnetic storage devices (e.g., hard disk, floppy disk, cassettes, tape . . . ), optical disks (e.g., compact disk (CD), digital versatile disk (DVD) . . . ), and solid state devices (e.g., solid state drive (SSD), flash memory drive (e.g., card, stick, key drive . . . ) . . . ), or any other medium which can be used to store the desired information and which can be accessed by the computer 1710.

Communication media typically embodies computer-readable instructions, data structures, program modules, or other data in a modulated data signal such as a carrier wave or other transport mechanism and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, RF, infrared and other wireless media. Combinations of any of the above should also be included within the scope of computer-readable media.

Memory 1730 and mass storage 1750 are examples of computer-readable storage media. Depending on the exact configuration and type of computing device, memory 1730 may be volatile (e.g., RAM), non-volatile (e.g., ROM, flash memory . . . ) or some combination of the two. By way of example, the basic input/output system (BIOS), including basic routines to transfer information between elements within the computer 1710, such as during start-up, can be stored in nonvolatile memory, while volatile memory can act as external cache memory to facilitate processing by the processor(s) 1720, among other things.

Mass storage 1750 includes removable/non-removable, volatile/non-volatile computer storage media for storage of large amounts of data relative to the memory 1030. For example, mass storage 1750 includes, but is not limited to, one or more devices such as a magnetic or optical disk drive, floppy disk drive, flash memory, solid-state drive, or memory stick.

Memory 1730 and mass storage 1750 can include, or have stored therein, operating system 1760, one or more applications 1762, one or more program modules 1764, and data 1766. The operating system 1760 acts to control and allocate resources of the computer 1710. Applications 1762 include one or both of system and application software and can exploit management of resources by the operating system 1760 through program modules 1764 and data 1766 stored in memory 1730 and/or mass storage 1750 to perform one or more actions. Accordingly, applications 1762 can turn a general-purpose computer 1710 into a specialized machine in accordance with the logic provided thereby.

All or portions of the claimed subject matter can be implemented using standard programming and/or engineering techniques to produce software, firmware, hardware, or any combination thereof to control a computer to realize the disclosed functionality. By way of example and not limitation, the server component 102 (or portions thereof), the patient manager component 110 (or portions thereof), and/or the treatment manager component 120 (or portions thereof) can be, or form part, of an application 1762, and include one or more modules 1764 and data 1766 stored in memory and/or mass storage 1750 whose functionality can be realized when executed by one or more processor(s) 1720. Moreover, it is to be appreciated that the software, firmware, or combination thereof to perform the functionality of the described components herein can be downloaded, installed, or a combination thereof from any host. For instance, the host can be an online store, a website, an IP address, an application store, a network, a storage medium, a portable hard disk, a server, or the Internet.

In accordance with one particular embodiment, the processor(s) 1720 can correspond to a system on a chip (SOC) or like architecture including, or in other words integrating, both hardware and software on a single integrated circuit substrate. Here, the processor(s) 1720 can include one or more processors as well as memory at least similar to processor(s) 1720 and memory 1730, among other things. Conventional processors include a minimal amount of hardware and software and rely extensively on external hardware and software. By contrast, an SOC implementation of processor is more powerful, as it embeds hardware and software therein that enable particular functionality with minimal or no reliance on external hardware and software. For example, the server component 102 (or portions thereof), the patient manager component 110 (and/or associated functionality), and/or the treatment manager component 120 (and/or associated functionality) can be embedded within hardware in a SOC architecture.

The computer 1710 also includes one or more interface components 1770 that are communicatively coupled to the system bus 1740 and facilitate interaction with the computer 1710. By way of example, the interface component 1770 can be a port (e.g., serial, parallel, PCMCIA, USB, FireWire . . . ) or an interface card (e.g., sound, video . . . ) or the like. In one example implementation, the interface component 1770 can be embodied as a user input/output interface to enable a user to enter commands and information into the computer 1710 through one or more input devices (e.g., pointing device such as a mouse, trackball, stylus, touch pad, keyboard, microphone, joystick, game pad, satellite dish, scanner, camera, other computer . . . ). In another example implementation, the interface component 1770 can be embodied as an output peripheral interface to supply output to displays (e.g., CRT, LCD, plasma . . . ), speakers, printers, and/or other computers, among other things. Still further yet, the interface component 1770 can be embodied as a network interface to enable communication with other computing devices (not shown), such as over a wired or wireless communications link.

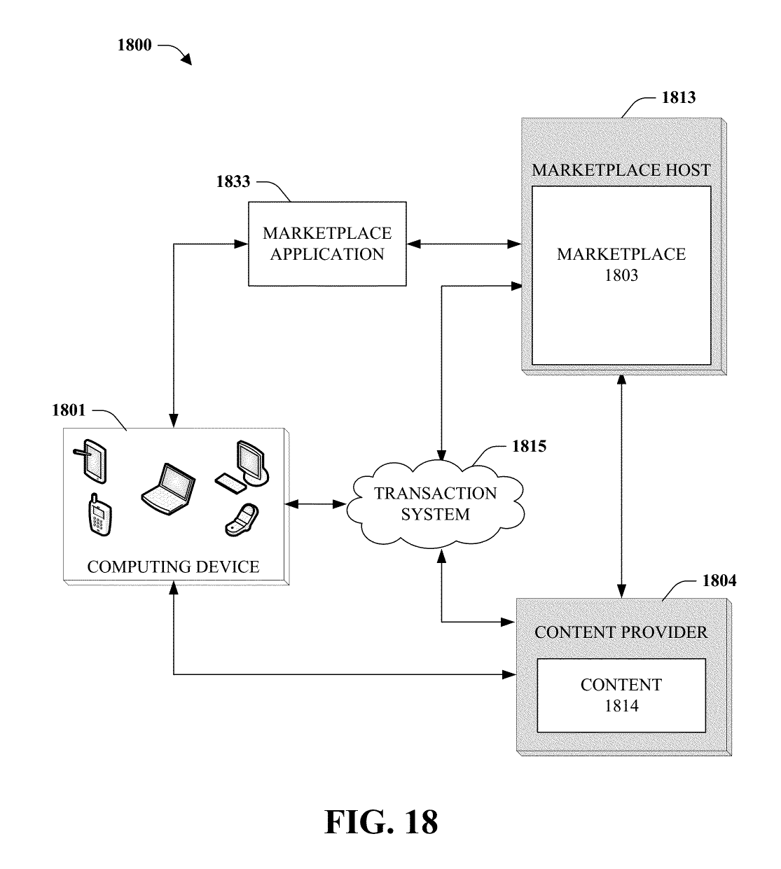

FIG. 18 illustrates an operating environment 1800 that can be used with the subject innovation and in particular, at least one of the patient manager component 110, the treatment manager component 120, or the server component 102. The operating environment 1800 includes a computing device 1801 (e.g., device smartphone, a tablet, a laptop, a desktop machine, a portable gaming device, a device with Internet connectivity, among others), a user, a marketplace 103, a content provider 1804, and content 1814. The operating environment 1800 is configured to deliver data (e.g., content 1814) to the computing device 1801 based upon a request from the computing device 1801 (e.g., typically initiated by a user of the computing device 1801). However, it may be appreciated that the delivery of data to the computing device 1801 can be pushed to the computing device 1801 and further approved (e.g. acceptance of license agreement, among others) by the user. The data delivered can be from a content provider 1804, wherein the data can be delivered directly to the computing device 1801 or indirectly delivered to the computing device 1801 via the marketplace 1803 and/or the marketplace applications 1833. In an embodiment, the computing device 1801 can utilize a transaction system 1815 that facilitates purchasing data via at least one of the marketplace 1803, the marketplace applications 1833, the content provider 1804, and the like. The transaction system 1815 can be configured to utilize a charging gateway to facilitate completing a transaction between entities (e.g., user, content provider, marketplace, among others).

The computing device 1801 and the marketplace 1803 can be configured to communicate across a network, for example, wherein the marketplace 1803 is accessed via the marketplace application 1833 or a user interface (UI) associated with one of the marketplace 1803 or the marketplace host 1813. The marketplace 1803 can be hosted by a marketplace host 1813 associated with any suitable host, server, computer, data store, and the like.

In one embodiment, the computing device 1801 is mobile so that it may function for a period of time without requiring a physical connection to a power source or network provider. For example, a cellular network or a Wi-Fi connection can be used by the computing device 1801 in order to transmit and/or receive data within the operating environment 1800.

A user can employ the computing device 1801 for the device's intended functions as well as communicating data with the marketplace 1803 and/or marketplace host 1813. Commonly, the user purchases content 1814 and/or products from the content provider 1804 via the transaction system 115. It is to be appreciated that the marketplace 1803 can be in an electronic form such as a website, the marketplace application 1833, or an executable program. In a preferred embodiment, the marketplace 1803 takes the form of the marketplace application 1833 configured to run on the user's computing device 1801. The marketplace application 1833 may be utilized to install the content 1814 from the content provider 1804 onto the computing device 1801.

The marketplace 1803 can further connect the content provider 1804 and/or the content 1814 of the content provider 1804 with the computing device 1801 to allow the user to receive content 1814 via a download (e.g., communication of data packets). The marketplace 1803 can offer the user a variety of content 1814 for purchase (via the transaction system 115) or for free of charge. The content 1814 offered by the marketplace 1803 may also come from the marketplace host 1813. For example, the content provider 1804 can have a website for direct delivery of content 1814 or have content 1814 hosted in the marketplace 1803 by the marketplace host 1813. Thus, in such an example, a user can directly receive data or content from the website of the content provider 1804 or use the marketplace application 1833 to identify the content 1814 for receipt through the marketplace 1803. Moreover, the content 1814 can be tailored to the computing device 1801. For instance, a first content can be built for a first computing device having a first operating system and a second content can be built for a second computing device having a second operating system, wherein the first content and the second content can be from the content provider 1804.

In some embodiments, the system 1800 utilizes the transaction system 1815. The transaction system 1815 can include a transaction gateway that facilitates transactions between at least the marketplace host 1813, one or more users, the marketplace 1803, and/or the content provider 1804. When the user purchases content 1814 from the marketplace 1803 or content provider 1804, a charging gateway can receive a request to apply a charge to a user account (e.g., a monetary value via an electronic transaction via an account) owned or authorized by the user. For example, the user account can be, but is not limited to being, a credit card account, an account with the content provider 1804 or marketplace host 1813, a bank account, a debit account, an e-commerce account (e.g. Pay-Pal®), an electronic account, a savings account, and the like.

The transaction gateway can store transaction data (e.g., user account, username, password, data related to the user, data related to the computing device 1801, among others) specific to a transaction to receive content 1814. The transaction gateway can further collect and/or store data regarding one or more users, wherein the data can be, but is not limited to, credit card numbers, to make it easier for the one or more users to engage in multiple transactions (e.g., simultaneously and/or various points in time). The transaction gateway can further reverse a transaction between one or more parties involved, such as providing a refund to the user.

It is to be appreciated that a purchase may not require the transfer of finances. For example, the content 1814 on the marketplace 1803 could be free to download. Additionally, a portion of the transaction system 1815 can be integrated into at least one of the content provider 1804, the marketplace host 1813, the marketplace application 1833, or a combination thereof. In another embodiment, the first content 1814 can be free but additional content related to the first content 1814 can require a purchase.

The content provider 1804 can create content 1814 (e.g., also referred to as products, software, apps, applications, and the like) that can be sold on the marketplace 1803. By way of example and not limitation, the content provider 1804 can be a videogame company that creates a game to be made available for download from the marketplace 1803. By way of another example and not limitation, a bank can develop a mobile banking application that is communicated to the marketplace 1803 and made available for download via the marketplace 1803. In such example, the bank is the content provider 1804. Additionally, the bank may host the mobile banking application on the bank's website for download or delivery to users. It is to be appreciated and understood that the content provider 1804 is not limited to these examples and the content provider 1804 can be any suitable entity (e.g., user, company, business, group of users, and the like) that creates or develops content 1814 to be distributed to the marketplace host 1813 for download via the marketplace 1803.

The marketplace host 1813 maintains the marketplace 1803 on a network. The marketplace host 1813 owns and/or controls a host server that contains the marketplace 1803, and provides the user access to the marketplace 1803. The marketplace host 1813 can further control an amount of bandwidth allocated to the user to download the content 1814 of the one or more content providers 1804. In a non-limiting embodiment, the marketplace host 1813 can own and/or control the marketplace 1803. In another non-limiting embodiment, the marketplace host 1813 can host the marketplace 1803 on a network to enable access by the user.

In an exemplary embodiment, a user accesses the marketplace 1803 via the marketplace application 1833 located on the computing device 1801. The computing device 1801 can have access to the network 1805, and the computing device 1801 can communicate data in the form of a query to the marketplace host 1813, wherein the data can be a request for information on content 1814. The marketplace host 1813 can communicate data in the form of a query result (which can include content 1814) via a network to the computing device 1801 for review, install, use, storage, and the like. In a non-limiting embodiment, the computing device 1801 can include a user-interface that displays the data (e.g., the query, the query result, the content 1814, among others) for the user.

Prior to download of content 1814, the user can further navigate information regarding the content 1814 that is displayed and select to either request additional content 1814 or to purchase the content 1814. If the user selects to purchase content 1814, the marketplace application 1833 communicates a purchase request to the marketplace host 1813. The marketplace host 1813 can then use the transaction system 1815 which includes the transaction gateway charging the user account if data related to the user account is available, and if the user account is not available, then the marketplace host 1813 can request user account 1812 information from the user which can then be sent to the transaction gateway. Upon receipt of the user account information, the transaction gateway can charge the user account, and send a confirmation of the transaction back to the marketplace host 1813.

The marketplace host 1813 can then communicate the confirmation information to the computing device 1801, as well as enable the user to download data for the content 1814 and/or the marketplace application 1833 stored in a host server regarding the specific content 1814 and/or marketplace application 1833 purchased. The marketplace application 1833 can further assist with installation of the content 1814 or marketplace application 1833 purchased onto the computing device 1801. It is to be appreciated and understood that the above process can occur in any order, such as a downloading of application information from the marketplace host 1813 prior to the transaction and the order of the above described process is not to be limiting on the subject innovation.

One of ordinary skill in the art can appreciate that the various embodiments of a subscription-based diagnostic software service described herein can be implemented in connection with any computing device, client device, or server device, which can be deployed as part of a computer network or in a distributed computing environment such as the cloud. The various embodiments described herein can be implemented in substantially any computer system or computing environment having any number of memory or storage units, any number of processing units, and any number of applications and processes occurring across any number of storage units and processing units. This includes, but is not limited to, cloud environments with physical computing devices (e.g., servers) aggregating computing resources (i.e., memory, persistent storage, processor cycles, network bandwidth, etc.) which are distributed among a plurality of computable objects. The physical computing devices can intercommunicate via a variety of physical communication links such as wired communication media (e.g., fiber optics, twisted pair wires, coaxial cables, etc.) and/or wireless communication media (e.g., microwave, satellite, cellular, radio or spread spectrum, free-space optical, etc.). The physical computing devices can be aggregated and exposed according to various levels of abstraction for use by application or service providers, to provide computing services or functionality to client computing devices. The client computing devices can access the computing services or functionality via application program interfaces (APIs), web browsers, or other standalone or networked applications. Accordingly, aspects of the subscription-based diagnostic software service can be implemented based on such a cloud environment. For example, at least one of the patient manager component 110, the treatment manager component 120, or the server component 102 can reside in the cloud environment such that the computer-executable instruction implementing the functionality thereof are executed with the aggregated computing resources provided by the plurality of physical computing devices. The cloud environment provides one or more methods of access to the subject innovation, which are utilized by at least one of the patient manager component 110, the treatment manager component 120, or the server component 102 that can be installed on mobile device 1960. These methods of access include IP addresses, domain names, URIs, etc. Since the aggregated computing resources can be provided by physical computing device remotely located from one another, the cloud environment can include additional devices such as a routers, load balancers, switches, etc., that appropriately coordinate network data.

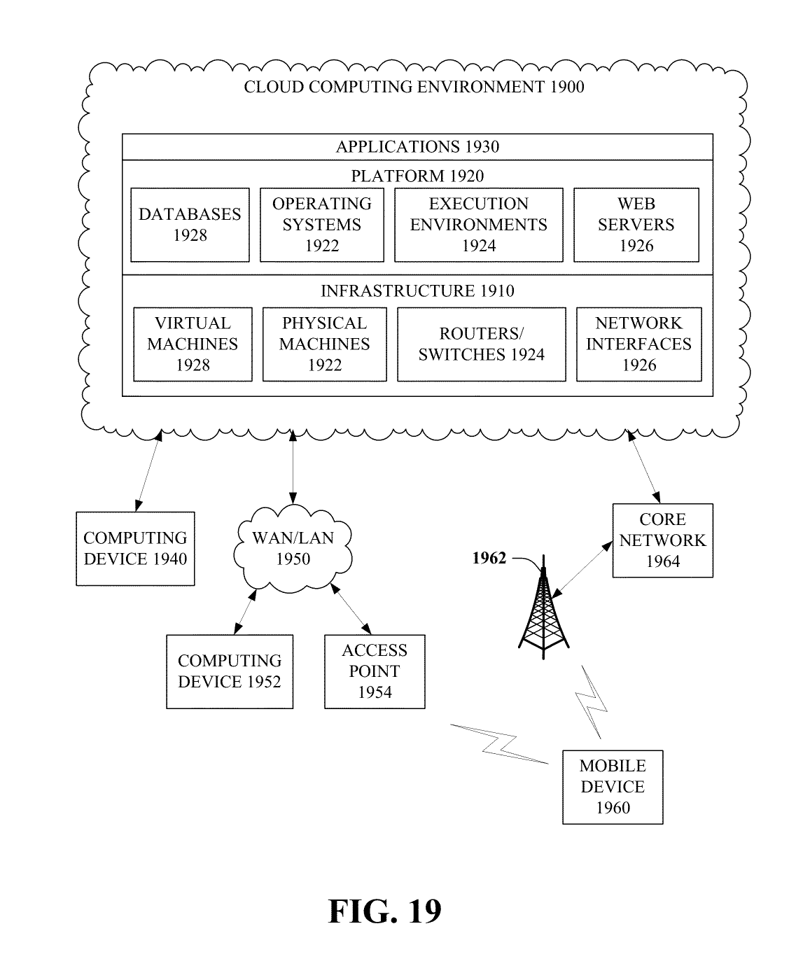

FIG. 19 provides a schematic diagram of an exemplary networked or distributed computing environment, such as a cloud computing environment 1900. The cloud computing environment 1900 represents a collection of computing resources available, typically via the Internet, to one or more client devices. The cloud computing environment 1900 comprises various levels of abstraction: infrastructure 1910, a platform 1920, and applications 1930. Each level, from infrastructure 1910 to applications 1930 is generally implemented on top of lower levels, with infrastructure 1910 representing the lowest level.

Infrastructure 1910 generally encompasses the physical resources and components on which cloud services are deployed. For instance, infrastructure 1910 can include virtual machines 1912, physical machines 1914, routers/switches 1916, and network interfaces 1918. The network interfaces 1918 provide access to the cloud computing environment 1900, via the Internet or other network, from client devices such as computing devices 1940, 1952, 1960, etc. That is, network interfaces 1918 provide an outermost boundary of cloud computing environment 1900 and can couple the cloud computing environment 1900 to other networks, the Internet, and client computing devices. Routers/switches 1916 couple the network interfaces 1918 to physical machines 1914, which are computing devices comprising computer processors, memory, mass storage devices, etc. Hardware of physical machines 1914 can be virtualized to provide virtual machines 1912. In an aspect, virtual machines 1912 can be executed on one or more physical machines 1914. That is, one physical machine 1914 can include a plurality of virtual machines 1912.

Implemented on infrastructure 1910, platform 1920 includes software that forming a foundation for applications 1930. The software forming platform 1920 includes operating systems 1922, programming or execution environments 1924, web servers 1926, and databases 1928. The software of platform 1920 can be installed on virtual machines 1912 and/or physical machines 1914.

Applications 1930 include user-facing software applications, implemented on platform 1920, that provide services to various client devices. In this regard, at least one of the patient manager component 110, the treatment manager component 120, or the server component 102 described herein is an example application 1930. As illustrated in FIG. 19, client devices can include computing devices 1940, 1952 and mobile device 1960. Computing devices 1940, 1952 can be directly coupled to the Internet, and therefore the cloud computing environment 1900, or indirectly coupled to the Internet via a WAN/LAN 1950. The WAN/LAN 1950 can include an access point 1954 that enables wireless communications (e.g., WiFi) with mobile device 1960. In this regard, via access point 1954 and WAN/LAN 1950, mobile device 1960 can communicate wirelessly with the cloud computing environment 1900. Mobile device 1960 can also wirelessly communicate according to cellular technology such as, but not limited to, GSM, LTE, WiMAX, HSPA, etc. Accordingly, mobile device 1960 can wireless communicate with a base station 1962, which is coupled to a core network 1964 of a wireless communication provider. The core network 1964 includes a gateway to the Internet and, via the Internet, provides a communication path to the cloud computing environment 1900.

In the specification and claims, reference will be made to a number of terms that have the following meanings. The singular forms “a”, “an” and “the” include plural referents unless the context clearly dictates otherwise. Approximating language, as used herein throughout the specification and claims, may be applied to modify a quantitative representation that could permissibly vary without resulting in a change in the basic function to which it is related. Accordingly, a value modified by a term such as “about” is not to be limited to the precise value specified. In some instances, the approximating language may correspond to the precision of an instrument for measuring the value. Moreover, unless specifically stated otherwise, a use of the terms “first,” “second,” etc., do not denote an order or importance, but rather the terms “first,” “second,” etc., are used to distinguish one element from another.

As used herein, the terms “may” and “may be” indicate a possibility of an occurrence within a set of circumstances; a possession of a specified property, characteristic or function; and/or qualify another verb by expressing one or more of an ability, capability, or possibility associated with the qualified verb. Accordingly, usage of “may” and “may be” indicates that a modified term is apparently appropriate, capable, or suitable for an indicated capacity, function, or usage, while taking into account that in some circumstances the modified term may sometimes not be appropriate, capable, or suitable. For example, in some circumstances an event or capacity can be expected, while in other circumstances the event or capacity cannot occur—this distinction is captured by the terms “may” and “may be.”

This written description uses examples to disclose the invention, including the best mode, and also to enable one of ordinary skill in the art to practice the invention, including making and using a devices or systems and performing incorporated methods. The patentable scope of the invention is defined by the claims, and may include other examples that occur to one of ordinary skill in the art. Such other examples are intended to be within the scope of the claims if they have structural elements that do not differentiate from the literal language of the claims, or if they include equivalent structural elements with insubstantial differences from the literal language of the claims.

1. A system that facilitates delivery of information between a treatment provider and a user, comprising:
a processor coupled to a memory, the processor configured to execute the following computer-executable components stored in the memory:
a server component that is configured to receive a health condition defined by a set of parameters, wherein one or more of the set of parameters mitigate the health condition;
the server component is further configured to establish a relationship between a treatment provider and a user, wherein the relationship is based on the health condition of the user;
the server component receives a kit prescribed by the treatment provider for the user, the kit includes a subset of the set of parameters defined for the health condition of the user;
the server component is further configured to communicate a device list for the user based on the kit prescribed, wherein the device list defines one or more devices that collect data representative of one or more of the subset of parameters included in the kit;
the server component is further configured to receive data representative of one or more of the subset of parameters included in the kit from at least one device selected by the user; and
the server component is further configured to communicate at least one of a health advice, a medical advice, or an adjustment of the kit to the user for further treatment of the health condition.

2. The system of claim 1, further comprising a criteria of the user, in addition to the health condition, is evaluated by the treatment provider to generate the kit.

3. The system of claim 2, wherein the criteria is a family medical history.

4. The system of claim 2, wherein the criteria is a genetic parameter of the user.

5. The system of claim 1, wherein the condition is related to a respiratory system of the user.

6. The system of claim 1, wherein the condition is related to a weight of the user.

7. The system of claim 1, wherein the condition is related to the mental health of the user.

8. The system of claim 1, wherein the condition is related to a cardiovascular system of the user.

9. The system of claim 1, wherein the one or more devices is at least one of a wearable device or a smartphone.

10. The system of claim 1, wherein the device list includes a data technique for manual entry of data representative of one or more of the subset of parameters defined in the kit.

11. The system of claim 1, further comprising:
a device specific network for the one or more devices that hosts data from the one or more devices; and
the server component utilizes authentication data of the user to collect data from the device specific network.

12. The system of claim 1, wherein the treatment provider creates the kit for the user and the device list is not communicated to the treatment provider.

13. The system of claim 12, wherein the user selects one or more devices from the device list and the subset of the parameters prescribed to the user is not communicated to the user.

14. The system of claim 1, further comprising a data exchange component that is configured to create a secure channel to communicate at least one of the kit, the device list, data collected that is representative of one or more subset of parameters defined in the kit, advice based on the data collected, or an adjustment of the kit based on the data collected, wherein the secure channel is created between a user and a treatment provider that have an established relationship to mitigate the health condition.

15. A method of delivering advice, comprising:
employing at least one processor configured to execute computer-executable instructions stored in memory to perform the following acts:
establishing a relationship between a user and a treatment provider based on a condition of the user;
communicating a set of parameters for the condition to the treatment provider;
assigning a subset of the set of parameters to the user;
communicating at least one device to the user that collects data representative of one or more of the subset of parameters;
collecting data representative of the one or more of the subset of parameters from the at least one device selected by the user;
communicating the collected data to the treatment provider; and
communicating from the treatment provider to the user, based on the collected data, at least one of a health advice, a medical advice, or an adjustment of the subset of the set of parameters.

16. The method of claim 15, further comprising selecting the subset of parameters based on the condition of the user and an additional criteria related to the user.

17. The method of claim 16, wherein the additional criteria is at least two of the following: a family medical history; a medical history; a previous health condition; a genetics of the user; a genetic makeup of the user; a diet; a disease; or a genetic sequencing of the user.

18. The method of claim 16, further comprising:
customizing the subset of parameters from the set of parameters for the condition with an additional parameter determined by the treatment provider; and
collecting data representative of the one or more of the subset of parameters and the additional parameter from the at least one device selected by the user.

19. The method of claim 16, further comprising:
using authentication data of the user to access a host specific to one or more of the devices selected by the user; and
receiving the collected data from the host specific to one or more of the devices selected by the user.

20. A system that facilitates delivery of information between a treatment provider and a user, comprising:
a processor coupled to a memory, the processor configured to execute the following computer-executable components stored in the memory:
a server component that is configured to receive a health condition defined by a set of parameters, wherein one or more of the set of parameters mitigate the health condition;
the server component is further configured to establish a relationship between a treatment provider and a user, wherein the relationship is based on the health condition of the user and a health insurance policy of the user;
the server component receives a kit defined by the treatment provider for the user, the kit includes a subset of the set of parameters for the health condition of the user in which the subset of set of parameters aids in the treatment of the health condition;
the server component is further configured to communicate a device list for the user based on the kit prescribed, wherein the device list defines one or more devices that collect data representative of one or more of the subset of parameters included in the kit;
the server component is further configured to receive data representative of one or more of the subset of parameters included in the kit from at least one device selected by the user;
the server component is further configured to communicate at least one of a health advice, a medical advice, or an adjustment of the kit to the user for further treatment of the health condition;
a data exchange component that is configured to create a secure channel to communicate at least one of the kit, the device list, data collected that is representative of one or more subset of parameters defined in the kit, advice based on the data collected, or an adjustment of the kit based on the data collected, wherein the secure channel is created between a user and a treatment provider that have an established relationship to mitigate the health condition;
wherein the treatment provider creates the kit for the user and the device list is not communicated to the treatment provider; and wherein the user selects one or more devices from the device list and the subset of the parameters defined in the kit for the user are not communicated to the user.
